(19) United States
(12) Patent Application Publication
(10) Pub. No.: US 2026/0295846 A1
(43) Pub. Date: Oct. 1, 2026

(54) DEVICE, ROBOT CONTROL DEVICE, ROBOT SYSTEM, AND METHOD

(71) Applicant: Fanuc Corporation, Minamitsuru-gun, Yamanashi (JP)

(72) Inventor: Jun WADA, Minamitsuru-gun, Yamanashi (JP)

(73) Assignee: Fanuc Corporation, Minamitsuru-gun, Yamanashi (JP)

(21) Appl. No.: 18/881,539

(22) PCT Filed: Aug. 23, 2022
(86) PCT No.: PCT/JP2022/031754

§ 371 Date: Jan. 6, 2025

(51) Int. Cl. B25J 9/16; G06T 7/50

(52) U.S. Cl. CPC B25J 9/1697; G06T 7/50; G06T 2207/30164

(57) ABSTRACT

This device includes: a model acquisition unit that acquires a plurality of workpiece models resulting from modeling a workpiece in a plurality of orientations, the workpiece models including a feature model corresponding to a visual feature of the workpiece; and an information acquisition unit that, with respect to a first workpiece model in one orientation, acquires non-similar information for identifying a first feature model that is in a non-similar relationship with the features of the workpiece in other orientations.

### CROSS REFERENCE TO RELATED APPLICATIONS

This is the U.S. National Phase application of PCT/JP2022/031754, filed Aug. 23, 2022, the disclosure of this application being incorporated herein by reference in its entirety for all purposes.

### FIELD OF THE INVENTION

The present disclosure relates to a device for acquiring dissimilarity information in a workpiece model, a robot controller, a robot system, and a method.

### BACKGROUND OF THE INVENTION

A device that acquires position data of a workpiece by matching a workpiece model modeling the workpiece with shape data of the workpiece detected by a shape detection sensor is known (e.g., a three-dimensional vision sensor) (e.g., Patent Literature 1).

### PATENT LITERATURE

PTL 1: JP 2017-102529 A

### SUMMARY OF THE INVENTION

There is a case in the related art in which erroneous detection of position data occurs due to erroneous matching of a workpiece model with detection data of a shape detection sensor.

In an aspect of the present disclosure, a device includes a model acquisition unit configured to acquire a plurality of workpiece models modeling a workpiece at a plurality of orientations, each workpiece model including a feature model corresponding to a visual feature of the workpiece; and an information acquisition unit configured to acquire dissimilarity information for identifying, in a first workpiece model at one of the plurality of orientations, a first feature model having a dissimilarity relationship with the feature of the workpiece at another of the plurality of orientations.

In a method of another aspect of the present disclosure, a processor: acquires a plurality of workpiece models modeling a workpiece at a plurality of orientations, each workpiece model including a feature model corresponding to a visual feature of the workpiece; and acquires dissimilarity information for identifying, in a first workpiece model at one of the plurality of orientations, a first feature model having a dissimilarity relationship with the feature of the workpiece at another of the plurality of orientations.

### BRIEF DESCRIPTION OF DRAWINGS

FIG. 1 is a schematic diagram of a robot system according to an embodiment.

FIG. 2 is a block diagram of the robot system illustrated in FIG. 1.

FIG. 3 illustrates a workpiece and a workpiece model arranged at a first orientation.

FIG. 4 illustrates the workpiece and the workpiece model arranged at a second orientation.

FIG. 5 illustrates the workpiece and the workpiece model arranged at a third orientation.

FIG. 6 illustrates an example of detection data detected by a shape detection sensor.

FIG. 7 is a diagram for explaining matching between the workpiece model and shape data, and illustrates an example in which the workpiece model appropriately matches the shape data.

FIG. 8 is a diagram for explaining matching between a workpiece model and shape data, and illustrates an example in which the workpiece model inappropriately matches the shape data.

FIG. 9 is a diagram for explaining matching between a workpiece model and shape data, and illustrates an example in which the workpiece model appropriately matches the shape data.

FIG. 10 is a diagram for explaining matching between a workpiece model and shape data, and illustrates an example in which the workpiece model inappropriately matches the shape data.

FIG. 11 is a block diagram illustrating other functions of the robot system.

FIG. 12 is a flow chart showing an example of an operation flow of the robot system illustrated in FIG. 11.

FIG. 13 is a block diagram illustrating other functions of the robot system.

FIG. 14 is a flow chart showing an example of an operation flow of the robot system illustrated in FIG. 13.

FIG. 15 is a block diagram illustrating other functions of the robot system.

FIG. 16 is a flow chart showing an example of an operation flow of the robot system illustrated in FIG. 15.

FIG. 17 is a flow chart showing an example of the flow of step S22 in FIG. 16.

FIG. 18 illustrates a state in which a workpiece model at a first orientation OR appropriately matches shape data.

FIG. 19 is a flow chart showing an example of the flow of step S23 in FIG. 16.

FIG. 20 is a block diagram illustrating other functions of the robot system.

FIG. 21 is a flow chart showing an example of an operation flow of the robot system illustrated in FIG. 20.

FIG. 22 is a diagram for explaining matching between a workpiece model and shape data, and illustrates an example in which the workpiece model inappropriately matches the shape data.

FIG. 23 is a diagram for explaining matching between a workpiece model and shape data, and illustrates an example in which the workpiece model inappropriately matches the shape data.

FIG. 24 is a flow chart showing an example of the flow of step S23 in FIG. 16 executed by the robot system illustrated in FIG. 20.

### DETAILED DESCRIPTION OF EMBODIMENTS OF THE INVENTION

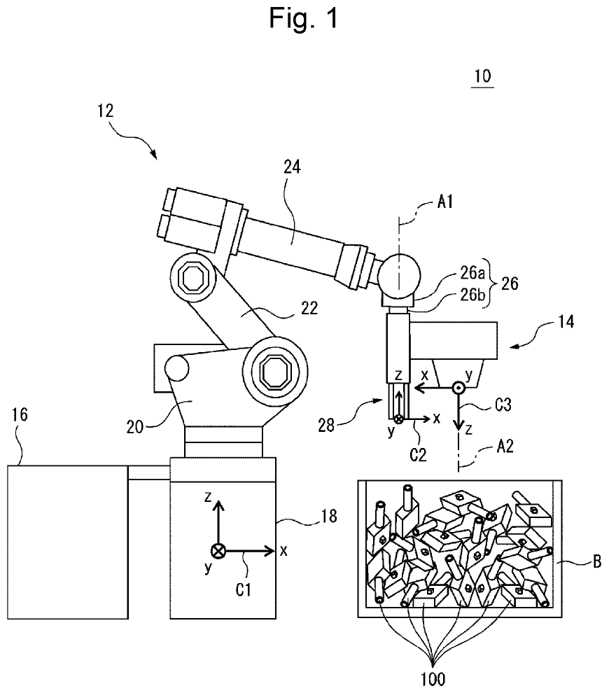

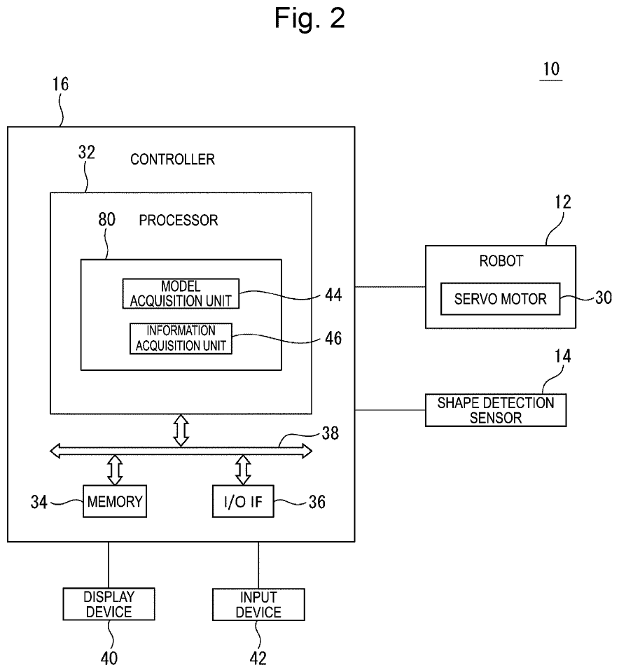

Embodiments of the present disclosure are described in detail below with reference to the drawings. Note that in various embodiments described below, the same elements are denoted with the same reference numerals, and overlapping description is omitted. First, a robot system 10 according to an embodiment will be described with reference to FIGS. 1 and 2. The robot system 10 includes a robot 12, a shape detection sensor 14, and a controller 16.

In the present embodiment, the robot 12 is a vertical articulated robot and includes a robot base 18, a swivel body 20, a lower arm 22, an upper arm 24, a wrist 26, and an end effector 28. The robot base 18 is fixed on the floor of a work cell. The swivel body 20 is provided on the robot base 18 so as to be able to swivel around the vertical axis.

The lower arm 22 is provided on the swivel body 20 such that its base end is pivotable about the horizontal axis, and the upper arm 24 is provided at the distal end of the lower arm 22 such that its base end is pivotable. The wrist 26 includes a wrist base 26a provided at the distal end of the upper arm 24 so as to be pivotable about two axes orthogonal to each other, and a wrist flange 26b provided at the wrist base 26a so as to be pivotable about a wrist axis A1.

The end effector 28 is removably attached to the wrist flange 26b. The end effector 28 may be, for example, a robot hand capable of gripping a workpiece 100, a welding torch for welding the workpiece 100, a laser processing head for subjecting the workpiece 100 to laser processing, or the like, and carries out predetermined work (workpiece handling, welding, or laser processing) on the workpiece 100.

Each constituent element (the robot base 18, the swivel body 20, the lower arm 22, the upper arm 24, and the wrist 26) of the robot 12 is provided with a servo motor 30 (FIG. 2). These servo motors 30 cause each movable element (the swivel body 20, the lower arm 22, the upper arm 24, the wrist base 26a, and the wrist flange 26b) of the robot 12 to pivot in response to a command from the controller 16. As a result, the robot 12 can make the end effector 28 move and arrange the end effector 28 at a freely-selected position.

The shape detection sensor 14 detects a shape of the workpiece 100. In the present embodiment, the shape detection sensor 14 is a three-dimensional vision sensor including an imaging sensor (CMOS, CCD, or the like) and an optical lens (collimator lens, focus lens, or the like) that guides a subject image to the imaging sensor, and is fixed to the end effector 28 (or the wrist flange 26b).

The shape detection sensor 14 is configured to image a subject along an optical axis A2 and measure a distance d to the subject. Note that the shape detection sensor 14 may be fixed to the end effector 28 such that the optical axis A2 and the wrist axis A1 are parallel (or orthogonal) to each other. The shape detection sensor 14 supplies the controller 16 with detection data DD obtained from detection.

As illustrated in FIG. 1, a robot coordinate system C1 and a tool coordinate system C2 are set for the robot 12. The robot coordinate system C1 is a control coordinate system C for controlling operations of each movable element of the robot 12. In the present embodiment, the robot coordinate system C1 is fixed to the robot base 18, with its origin disposed at the center of the robot base 18 and with its z-axis parallel to (specifically, coinciding with) the swivel axis of the swivel body 20.

On the other hand, the tool coordinate system C2 is a control coordinate system C for defining a position and an orientation of the end effector 28 in the robot coordinate system C1. In the present embodiment, the tool coordinate system C2 is set with respect to the end effector 28 such that the origin (so-called TCP) is arranged at a work position (e.g., a workpiece gripping position, a welding position, or a laser beam emission port) of the end effector 28 and the z-axis thereof is parallel to (specifically, coincides with) the wrist axis A1.

When moving the end effector 28, the controller 16 sets the tool coordinate system C2 in the robot coordinate system C1, and generates a command to each of the servo motors 30 of the robot 12 so as to arrange the end effector 28 at a position and orientation represented by the set tool coordinate system C2. In this way, the controller 16 can position the end effector 28 at freely-selected position and orientation in the robot coordinate system C1.

On the other hand, a sensor coordinate system C3 is set for the shape detection sensor 14. The sensor coordinate system C3 is a control coordinate system C for defining a position and an orientation (i.e., a position and a direction of the optical axis A2) of the shape detection sensor 14 in the robot coordinate system C1. In the present embodiment, the sensor coordinate system C3 is set with respect to the shape detection sensor 14 such that the origin thereof is arranged at the center of the imaging sensor of the shape detection sensor 14 and the z-axis thereof is parallel to (specifically, coincides with) the optical axis A2. The sensor coordinate system C3 defines coordinates of each pixel of the detection data DD (or the imaging sensor) detected by the shape detection sensor 14.

The positional relationship between the sensor coordinate system C3 and the tool coordinate system C2 is known through calibration, and thus, the coordinates of the sensor coordinate system C3 and the coordinates of the tool coordinate system C2 can be mutually transformed through a known transformation matrix (e.g., a homogeneous transformation matrix). Furthermore, since the positional relationship between the tool coordinate system C2 and the robot coordinate system C1 is known, the coordinates of the sensor coordinate system C3 and the coordinates of the robot coordinate system C1 can be mutually transformed through the tool coordinate system C2. That is, a position and an orientation (specifically, coordinates of the sensor coordinate system C3) of the shape detection sensor 14 in the robot coordinate system C1 are known.

The controller 16 controls operations of the robot 12 to perform predetermined work (workpiece handling, welding, or laser processing) on the workpiece 100. Specifically, the controller 16 is a computer including a processor 32, a memory 34, and an I/O interface 36 as illustrated in FIG. 2. The processor 32 includes a CPU, a GPU, or the like, is communicatively connected to the memory 34 and the I/O interface 36 via a bus 38, and performs arithmetic processing for implementing various functions described below while communicating with these components.

The memory 34 includes a RAM, a ROM, or the like and temporarily or permanently stores various types of data. The memory 34 can include a storage medium such as a volatile memory, a nonvolatile memory, a magnetic storage medium, or an optical storage medium. The I/O interface 36 includes, for example, an Ethernet (trade name) port, a USB port, an optical fiber connector, or an HDMI (trade name) terminal and communicates data with external devices by wire or wirelessly in response to a command from the processor 32. Each of the servo motors 30 and the shape detection sensor 14 of the robot 12 are communicatively connected to the I/O interface 36.

The controller 16 is provided with a display device 40 and an input device 42. The display device 40 and the input device 42 are communicatively connected to the I/O interface 36. The display device 40 includes a liquid crystal display or an organic EL display, and visibly displays various data in response to a command from the processor 32.

The input device 42 includes a push button, a switch, a keyboard, a mouse, or a touchscreen, and receives data input from an operator. Note that the display device 40 and the input device 42 may be integrally incorporated in a housing of the controller 16, or may be externally attached to the housing as one computer (PC, or the like) separate from the housing of the controller 16.

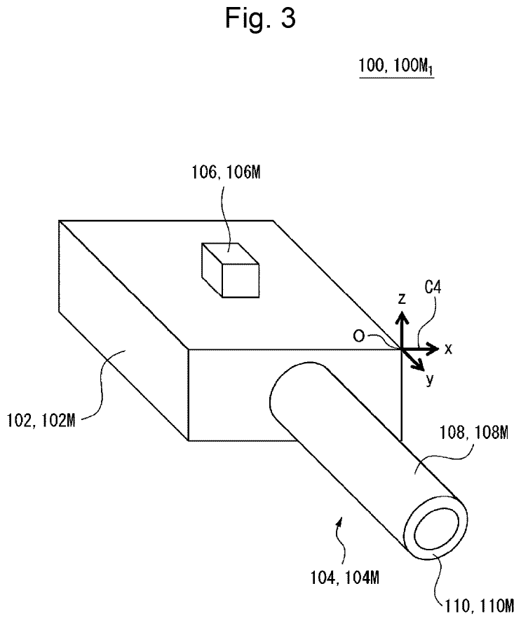

In the present embodiment, the processor 32 acquires position data PD of a plurality of workpieces 100 piled in bulk in a container B in the robot coordinate system C1 based on the detection data DD of the shape detection sensor 14 that detects the shapes of the workpieces 100. Hereinafter, an example of the workpiece 100 will be described with reference to FIGS. 3 to 5.

In the present embodiment, the workpiece 100 includes a main body 102, a shaft 104, and a protrusion 106. The main body 102 has a square prism outer shape. The shaft 104 has a cylindrical shape and protrudes from one side surface of the main body 102. The shaft 104 has a cylindrical side surface 108 and a ring-shaped end surface 110. The protrusion 106 has a square prism shape and protrudes from the top surface of the main body 102.

The main body 102 (specifically, edges and surfaces defining the main body 102), the shaft 104 (specifically, the side surface 108, the end surface 110, and edges thereof), and the protrusion 106 (specifically, edges and surfaces defining the protrusion 106) constitute visual features 102, 104, 106, 108, and 110 of the workpiece 100.

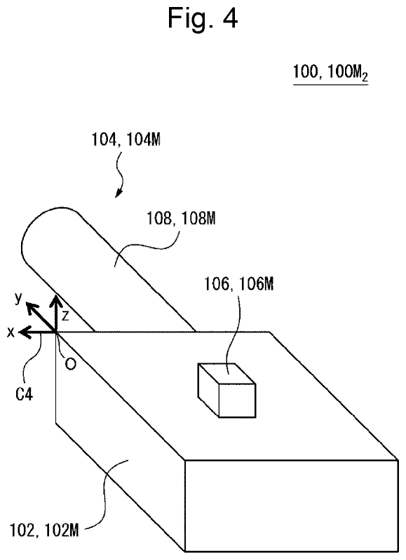

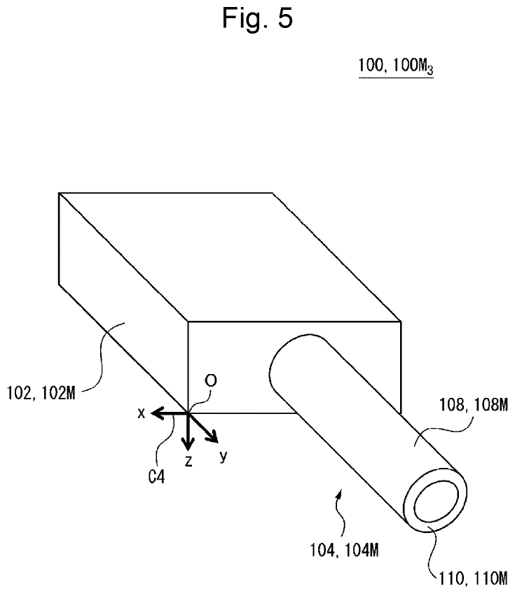

FIGS. 3 and 4 illustrate the workpiece 100 at three mutually different orientations ORₙ (n=1, 2, 3) when the workpiece 100 is viewed from three different viewpoints. Specifically, FIG. 3 illustrates the workpiece 100 at a first orientation OR₁, FIG. 4 illustrates the workpiece 100 at a second orientation OR₂, and FIG. 5 illustrates the workpiece 100 at a third orientation OR₃.

In the present embodiment, the processor 32 acquires a plurality of workpiece models 100Mₙ obtained by modeling the workpiece 100 at a plurality of orientations ORₙ as illustrated in FIGS. 3 to 5. The workpiece model 100Mₙ includes, for example, a CAD model 100Mcₙ of the workpiece 100 and a point group model 100Mpₙ representing model components (edge, surface, and the like) of the CAD model 100Mcₙ as a point group (or normal line).

The CAD model 100Mcₙ is a three-dimensional CAD model and is created in advance by an operator using a CAD device (not illustrated). The processor 32 may generate the point group model 100Mpₙ by acquiring the CAD model 100Mcₙ from the CAD device and imparting the point group to the model component of the CAD model 100Mcₙ in accordance with a predetermined image generation algorithm. Note that, the workpiece model 100Mₙ is not limited to the CAD model 100Mcₙ and the point group model 100Mpₙ, and may be any type of model representing the shape of the workpiece 100.

The processor 32 acquires a workpiece model 100M₁ at the first orientation OR₁ obtained by modeling the workpiece 100 at the first orientation OR₁ illustrated in FIG. 3. Note that, in the following description, a model corresponding to a feature XXX (e.g., the end surface 110) of the workpiece 100 is referred to as a feature model XXXM (e.g., an end surface model 110M). The workpiece model 100M₁ at the first orientation OR₁ includes a main body model 102M, a shaft model 104M (to be specific, a side surface model 108M and an end surface model 110M), and a protrusion model 106M.

In addition, the processor 32 acquires a workpiece model 100M₂ at the second orientation OR₂ obtained by modeling the workpiece 100 at the second orientation OR₂ illustrated in FIG. 4. The workpiece model 100M₂ at the second orientation OR₂ includes the main body model 102M, the shaft model 104M, and the protrusion model 106M. However, in the workpiece model 100M₂, while the shaft model 104M has the side surface model 108M, it does not have the end surface model 110M (i.e., it cannot be seen from the viewpoint of FIG. 4).

In addition, the processor 32 acquires a workpiece model 100M₃ at the third orientation OR₃ obtained by modeling the workpiece 100 at the third orientation OR₃ illustrated in FIG. 5. The workpiece model 100M₃ at the third orientation OR₃ includes the main body model 102M and the shaft model 104M (to be specific, the side surface model 108M and the end surface model 110M), but does not include the protrusion model 106M (i.e., it cannot be seen from the viewpoint of FIG. 5).

A workpiece coordinate system C4 is set for each workpiece model 100Mₙ. The workpiece coordinate system C4 is a coordinate system for representing a position and an orientation of the workpiece model 100Mₙ in the control coordinate system C (specifically, the robot coordinate system C). In the present embodiment, the workpiece coordinate system C4 is set with respect to the workpiece model 100Mₙ such that its origin is disposed at the vertex O of the main body model 102M, its x-axis is parallel to the width direction of the main body model 102M, its y-axis is parallel to the lengthwise direction of the main body model 102M (or the axial line of the shaft model 104M), and its z-axis is parallel to the heightwise direction of the main body model 102M.

The processor 32 individually acquires a plurality of workpiece models 100Mₙ at various orientations ORₙ as illustrated in FIGS. 3 to 5 as separate pieces of model data. Further, although the workpiece models 100Mₙ at the three orientations ORₙ (n=1, 2, 3) are illustrated in the example illustrated in FIGS. 3 to 5, the processor 32 may acquire the workpiece models 100Mₙ at the three or more orientation ORₙ (e.g., n=1 to 500). As described above, in the present embodiment, the processor 32 functions as a model acquisition unit 44 (FIG. 2) configured to acquire the plurality of workpiece models 100Mₙ modeling the workpiece 100 at the plurality of orientations ORₙ.

Note that, the workpiece model 100Mₙ may include only front-side model data that is visible when viewed from a corresponding viewpoint, and may not include back-side model data that is invisible when viewed from the viewpoint. For example, while the workpiece model 100M₂ of FIG. 4 has only the model data on the front side of the sheet of FIG. 4 (the model data of the main body model 102M, the side surface model 108M, and the protrusion model 106M) which is visible when viewed from the viewpoint of FIG. 4, it may not have model data on the back side of the sheet of FIG. 4 (the model data of the end surface model 110M) which is invisible when viewed from the viewpoint of FIG. 4.

More specifically, when generating the workpiece model 100M₂ of FIG. 4 as a point group model 100Mp₂, the processor 32 generates model data of the point group of the model components on the front side of the sheet that are visible in FIG. 4, but may not generate model data of the point group of the model components on the back side of the sheet that are invisible (i.e., the edges, the surfaces, and the like on the back side when viewed from the viewpoint of FIG. 4). Note that the same applies to the workpiece model 100M₁ of FIG. 3 and the workpiece model 100M₃ of FIG. 5. This configuration can reduce the data amount of the workpiece model 100Mₙ to be acquired.

Note that the processor 32 may receive an input for setting the workpiece coordinate system C4 to the workpiece model 100Mₙ from the operator through the input device 42. The processor 32 stores the acquired plurality of workpiece models 100Mₙ in the memory 34 together with the setting information of the workpiece coordinate system C4.

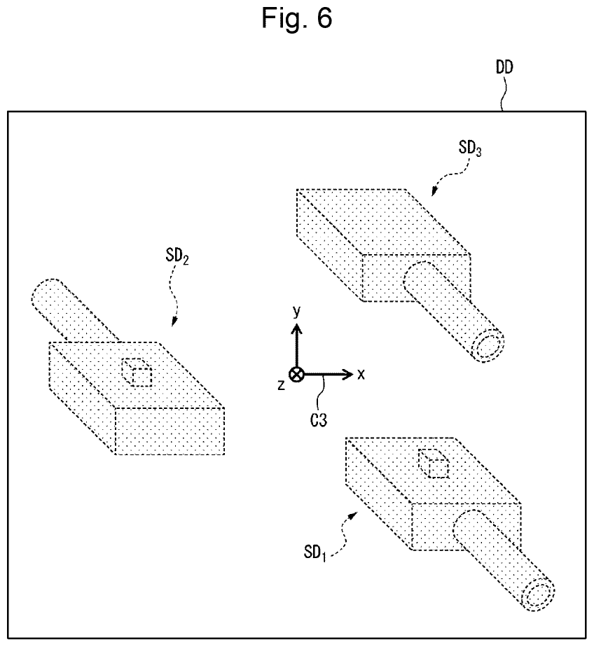

The processor 32 acquires the position data PD of the workpiece 100 in the robot coordinate system C1 by matching each of the acquired plurality of workpiece models 100Mₙ with the detection data DD detected by the shape detection sensor 14 imaging the workpieces 100 in the container B. FIG. 6 schematically illustrates an example of the imaged detection data DD.

In the present embodiment, the detection data DD is three-dimensional point group image data and includes shape data SDᵢ (i=1, 2, 3, . . . ) of the workpiece 100 at various orientations detected by the shape detection sensor 14. Note that, for easy understanding, FIG. 6 illustrates an example in which shape data SD₁ of the workpiece 100 at the first orientation OR₁, shape data SD₂ of the workpiece 100 at the second orientation OR₂, and shape data SD₃ of the workpiece 100 at the third orientation OR₃ are captured. However, it should be understood that three or more pieces of shape data SDᵢ may be photographed in the detection data DD when the shape detection sensor 14 actually images the workpieces 100 piled in bulk in the container B.

Each piece of the shape data SDᵢ has a point group indicating a visual feature of the workpiece 100 (i.e., an edge or a surface of the main body 102, an edge or a surface of the shaft 104 (the side surface 108 or the end surface 110), and an edge or a surface of the protrusion 106), and each point constituting the point group has information on the above-described distance d. Thus, each point constituting the point group of the shape data SDᵢ can be represented as three-dimensional coordinates (Xs, Ys, Zs) in the sensor coordinate system C3.

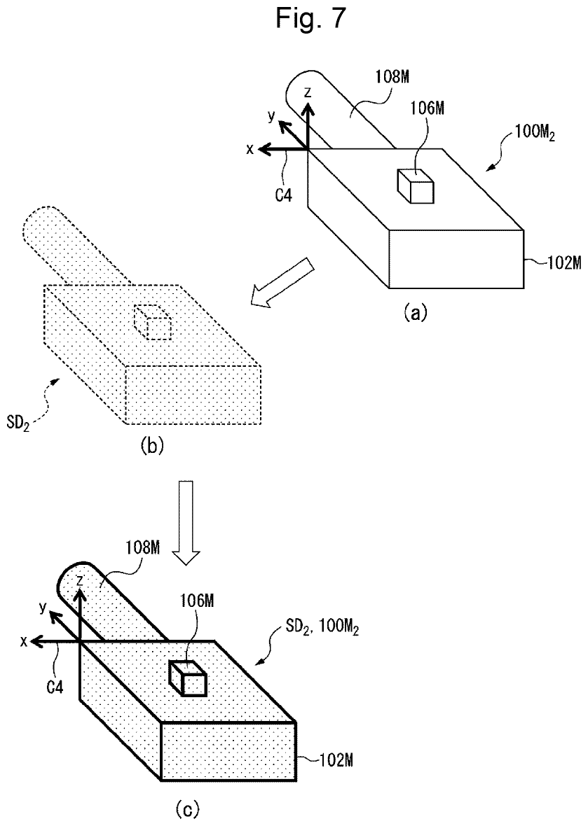

In the sensor coordinate system C3, the processor 32 matches the plurality of workpiece models 100Mₙ with pieces of the shape data SDᵢ appearing in the detection data DD, respectively. For example, as illustrated in FIG. 7, the processor 32 matches the workpiece model 100M₂ at the second orientation OR₂ (FIG. 7(a)) with the shape data SD₂ (FIG. 7(b)) appearing in the detection data DD.

In this case, as illustrated in FIG. 7(c), all the feature models of the workpiece model 100M₂ (the main body model 102M, the side surface model 108M, and the protrusion model 106M) are consistent with the features of the shape data SD₂ (the shape data of the main body 102, the side surface 108, and the protrusion 106 of the workpiece 100). That is, in this case, the workpiece model 100M₂ appropriately matches the shape data SDᵢ, and the workpiece coordinate system C4 set for the workpiece model 100M₂ at this time accurately represents the position and the orientation of the workpiece 100 detected as the shape data SD₂.

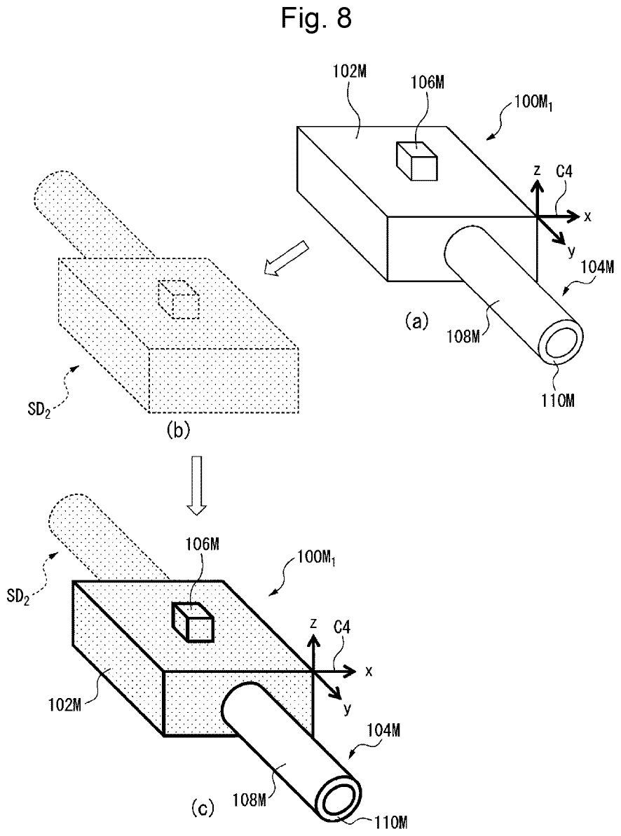

On the other hand, as illustrated in FIG. 8, the processor 32 similarly matches the workpiece model 100M₁ (FIG. 8(a)) at the first orientation OR₁ with the shape data SD₂ (FIG. 8(b)) appearing in the detection data DD. In this case, as illustrated in FIG. 8(c), the main body model 102M and the protrusion model 106M of the workpiece model 100M₁ match the features of the main body 102 and the protrusion 106 appearing in the shape data SD₂.

On the other hand, the shaft model 104M (to be specific, the side surface model 108M and the end surface model 110M) of the workpiece model 100M₁ is inconsistent with the features of the shaft 104 appearing in the shape data SD₂. That is, in this case, the workpiece model 100M₁ inappropriately matches the shape data SD₂, and the workpiece coordinate system C4 set for the workpiece model 100M₁ at this time does not accurately represent the position and the orientation of the workpiece 100 detected as the shape data SD₂.

Such inappropriate matching may occur due to the fact that the main body model 102M and the protrusion model 106M of the workpiece model 100M₁ are similar to the features of the main body 102 and the protrusion 106 appearing in the shape data SD₂. On the other hand, the end surface model 110M of the workpiece model 100M₁ does not exist in the shape data SD₂, and thus is dissimilar to any feature appearing in the shape data SD₂. As a result, the end surface model 110M having a dissimilarity relationship with the features of the shape data SD₂ is not consistent with any feature of the shape data SD₂ in the inappropriate matching as illustrated in FIG. 8(c).

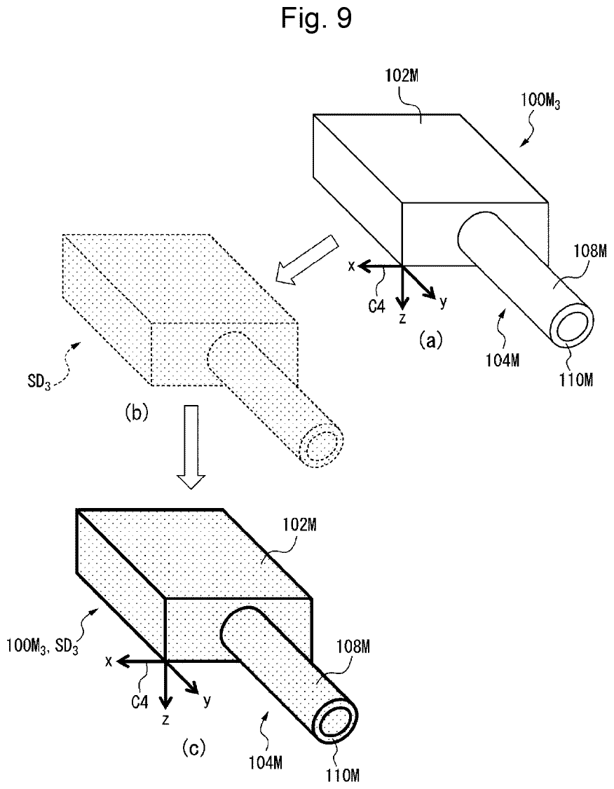

In addition, the processor 32 matches each of the plurality of workpiece models 100Mₙ with the shape data SD₃ appearing in the detection data DD of FIG. 6. For example, as illustrated in FIG. 9, the processor 32 matches the workpiece model 100M₃ at the third orientation OR₃ (FIG. 9(a)) with the shape data SD₃ (FIG. 9(b)) appearing in the detection data DD. As a result, the workpiece model 100M₃ and the shape data SD₃ appropriately match (FIG. 9(c)).

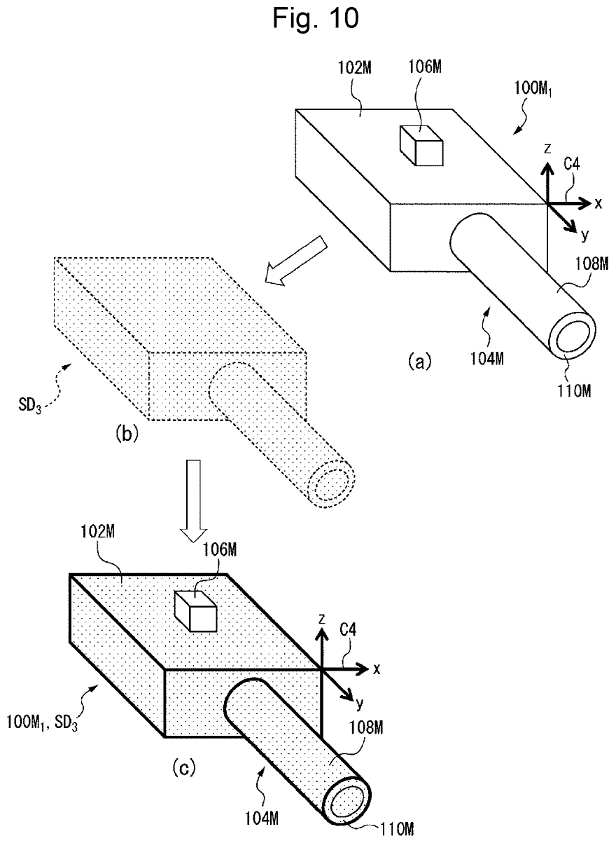

On the other hand, as illustrated in FIG. 10, the processor 32 likewise matches the workpiece model 100M₁ (FIG. 10(a)) at the first orientation OR₁ with the shape data SD₃ (FIG. 10(b)) appearing in the detection data DD. In this case, as illustrated in FIG. 10(c), the protrusion model 106M of the workpiece model 100M₁ is not consistent with any feature of the shape data SD₃, and thus the workpiece model 100M₁ inappropriately matches the shape data SD₃.

Such inappropriate matching may occur due to the fact that the main body model 102M and the shaft model 104M of the workpiece model 100M₁ are similar to the features of the main body 102 and the shaft 104 appearing in the shape data SD₃. On the other hand, the protrusion model 106M of the workpiece model 100M₁ does not exist in the shape data SD₃, and thus is dissimilar to any feature appearing in the shape data SD₃. As a result, when the inappropriate matching as illustrated in FIG. 10(c) is performed, the protrusion model 106M having a dissimilarity relationship with the features of the shape data SD₃ is not consistent with any feature of the shape data SD₃.

As described above, when a workpiece model 100Mₙ at an n-th orientation ORₙ matches shape data SDₘ at an m-th orientation ORₘ (m≠n), it is possible to determine whether or not the matching is inappropriate by paying attention to the feature model (e.g., the end surface model 110M in FIG. 8(c) or the protrusion model 106M in FIG. 10(c)) having a dissimilarity relationship with the feature of the shape data SDₘ (i.e., the workpiece 100 at the m-th orientation ORₘ) among the feature models included in the workpiece model 100Mₙ.

Therefore, in the present embodiment, in the workpiece model 100Mₙ at the n-th orientation ORₙ, dissimilarity information NI for identifying a feature model (i.e., the end surface model 110M in FIG. 8(c) or the protrusion model 106M in FIG. 10(c)) having a dissimilarity relationship with the feature of the workpiece 100 at the m-th orientation ORₘ is acquired.

For example, in the workpiece model 100M₁ at the first orientation OR₁ illustrated in FIG. 8, the processor 32 acquires dissimilarity information NI_{1_2} for identifying the end surface model 110M as a feature model having a dissimilarity relationship with the feature of the workpiece 100 at the second orientation OR₂ (i.e., the shape data SD₂). As an example, the operator may visually verify the feature of the workpiece model 100M₁ (e.g., the CAD-model 100M_{c1}) displayed on the display device 40 and manually input the dissimilarity information NI_{1_2} for identifying the end surface model 110M to the processor 32 by operating the input device 42.

As another example, the processor 32 may automatically acquire the dissimilarity information NI_{1_2} for identifying the end surface model 110M by attempting an operation of matching the workpiece model 100M₁ with the detection data DD obtained by the shape detection sensor 14 imaging the workpiece 100 in the real space or a virtual space. Note that details of the function of acquiring the dissimilarity information NI_{1_2} by attempting matching will be described below.

Similarly, the processor 32 may acquire dissimilarity information NI_{1_3} for identifying the protrusion model 106M as a feature model having a dissimilarity relationship with the feature of the workpiece 100 at the third orientation OR₃ in the workpiece model 100M₁ at the first orientation OR₁ illustrated in FIG. 10. As described above, in the present embodiment, the processor 32 acquires the dissimilarity information NI_{1_2} or NI_{1_3} for identifying the feature model 110M or 106M having a dissimilarity relationship with the feature of the workpiece 100 at the other orientation OR₂ or OR₃ in the workpiece model 100M₁ at one orientation OR₁. Accordingly, the processor 32 functions as an information acquisition unit 46 (FIG. 2) configured to acquire the dissimilarity information NI_{1_2} or NI_{1_3}.

Note that the dissimilarity information NI may be an identification code (a character string, a symbol, or the like) for identifying the feature model (the end surface model 110M or the protrusion model 106M) or a flag. The processor 32 stores the acquired dissimilarity information NI in the memory 34 to be attached to the model data of the workpiece model 100Mₙ or in association with the model data of the workpiece model 100Mₙ.

As described above, in the present embodiment, the processor 32 functions as the model acquisition unit 44 and the information acquisition unit 46 to acquire the dissimilarity information NI of the workpiece model 100Mₙ. Thus, the model acquisition unit 44 and the information acquisition unit 46 constitute a device 80 (FIG. 2) for acquiring the dissimilarity information NI.

In the device 80, the model acquisition unit 44 acquires a plurality of workpiece models 100Mₙ obtained by modeling the workpiece 100 at a plurality of orientations ORₙ, respectively, and the information acquisition unit 46 acquires the dissimilarity information NI_{1_2} or NI_{1_3} for identifying the feature model 110M or 106M having a dissimilarity relationship with the feature of the workpiece 100 at another orientation OR₂ or OR₃ with respect to the workpiece model 100M₁ at the one orientation OR₁.

According to the device 80, the processor 32 can identify the feature model 110M or the 106M of the workpiece model 100Mₙ to which attention should be paid in order to detect the above-described inappropriate matching. As a result, since such inappropriate matching can be detected with high accuracy, erroneous detection of the position data PD of the workpiece 100 can be reduced.

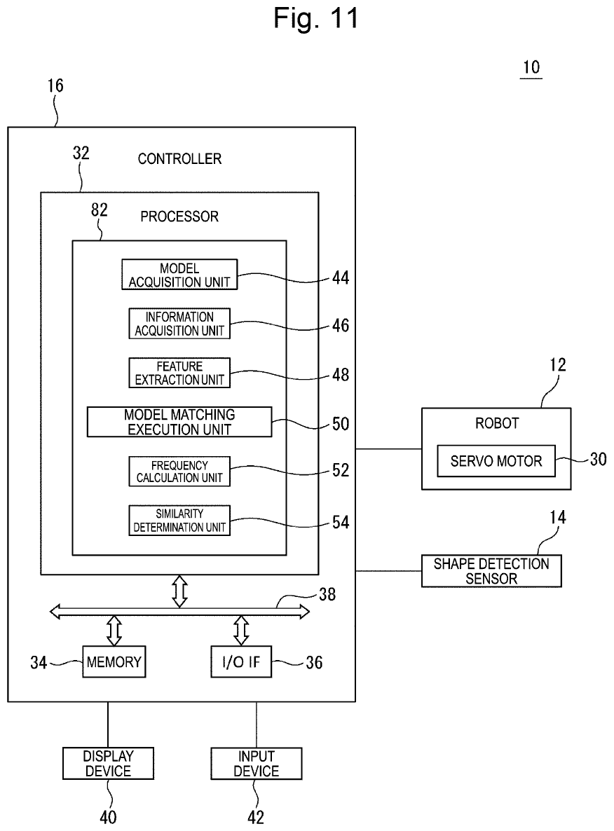

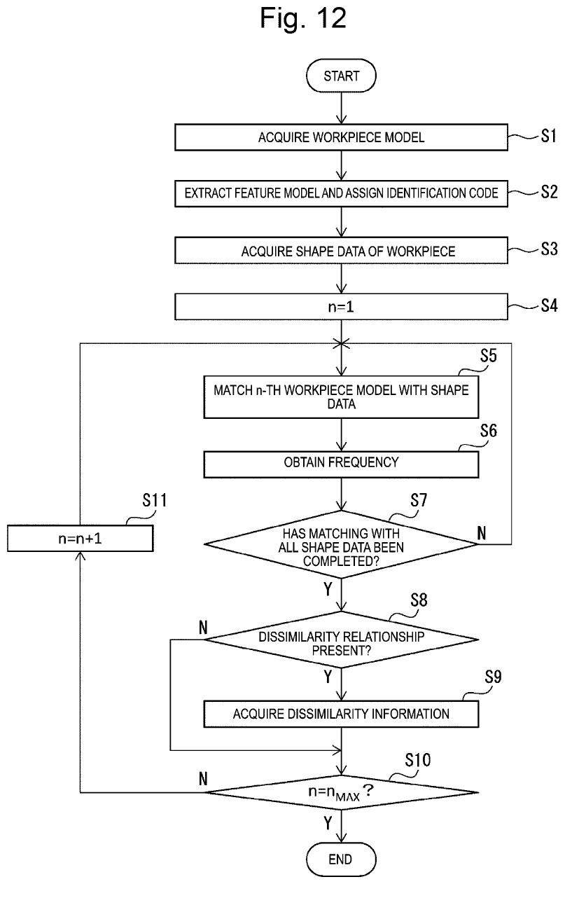

Subsequently, another function of the robot system 10 will be described with reference to FIG. 11. The robot system 10 illustrated in FIG. 11 acquires the flow shown in FIG. 12. The flow shown in FIG. 12 is a flow for acquiring the above-described dissimilarity information NI. The flow shown in FIG. 12 starts when the processor 32 receives an operation start command from the operator, the upper controller, or a computer program PG.

In step S1, the processor 32 serves as the model acquisition unit 44 to acquire a plurality of workpiece models 100Mₙ. To be specific, the processor 32 acquires each of the plurality of workpiece models 100Mₙ at a plurality of orientations ORₙ (e.g., n=1 to 500) as illustrated in FIGS. 3 to 5. The processor 32 may acquire the workpiece models 100Mₙ as CAD models 100Mcₙ or point group models.

In step S2, the processor 32 extracts a plurality of feature models included in the workpiece models 100Mₙ from each of the workpiece model 100Mₙ acquired in step S1 and assigns identification codes ID to the extracted feature models, respectively. For example, the processor 32 extracts, as the feature models, the main body model 102M, the side surface model 108M, the end surface model 110M, and the protrusion model 106M from the workpiece model 100M₁ at the first orientation OR₁ illustrated in FIG. 3.

Then, the processor 32 assigns unique identification codes ID to the extracted main body model 102M, side surface model 108M, end surface model 110M, and protrusion model 106M, respectively. For example, the identification codes ID are character string codes (e.g., “Feature group A”, “Feature group B”, “Feature group C”, . . . ). By the identification codes ID, the processor 32 can individually identify the feature models 102M, 108M, 110M, and 106M included in the workpiece model 100M₁. As described above, in the present embodiment, the processor 32 functions as a feature extraction unit 48 (FIG. 11) which extracts feature models from workpiece models 100Mₙ and assigns identification codes ID to the feature models.

Note that the processor 32 may extract a plurality of model components included in a workpiece model 100Mₙ as one feature model. For example, the processor 32 may extract the side surface model 108M and the end surface model 110M of the workpiece model 100M₃ at the third orientation OR₃ illustrated in FIG. 5 as one feature model 104M, and assign an identification code ID (a character string code such as “Feature group C”) to the one feature model 104M. The same applies to the main body model 102M and the protrusion model 106M constituted by model components of a plurality of surfaces and edges.

In addition, the present invention is not limited to extracting each of the main body model 102M, the side surface model 108M, the end surface model 110M, and the protrusion model 106M as one feature model, and for example, a combination of the main body model 102M and the protrusion model 106M may be extracted as one feature model, or each of a plurality of surfaces or edges defining the main body model 102M may be extracted as one feature model. Whether model components included in a workpiece model 100Mₙ are extracted as feature models may be arbitrarily determined by the operator.

In step S3, the processor 32 acquires shape data SDᵢ of the workpiece 100. As an example, the processor 32 acquires detection data DD (FIG. 6) obtained by actually imaging the workpieces 100 piled in bulk in the container B by the shape detection sensor 14 as the actual machine disposed in the actual space.

As another example, the processor 32 acquires the detection data DD obtained by executing a simulation SL in which a virtual shape detection sensor 14 disposed in a virtual space simulatively images the workpieces 100 piled in bulk in the container B (e.g., the workpiece models 100M disposed in a model of the container B).

For example, the shape data SDᵢ (i=1, 2, 3, . . . ) of the plurality of workpieces 100 at various orientations ORᵢ are included in the detection data DD acquired in that manner as illustrated in FIG. 6. Next, in step S4, the processor 32 sets a number “n” specifying an orientation ORₙ of the workpiece model 100Mₙ acquired in step S1 to “1”.

In step S5, the processor 32 matches the workpiece model 100Mₙ at the n-th orientation ORₙ with the shape data SDᵢ detected by the shape detection sensor 14. For example, when n=1 is set at the start of step S5, the processor 32 matches the workpiece model 100M₁ (FIG. 3) at the first orientation OR₁ acquired in step S1 with one shape data SD_{iI} (e.g., the shape data SD₁, SD₂, or SD₃) appearing in the detection data DD (FIG. 6) acquired in step S3 in accordance with a predetermined matching algorithm. As described above, in the present embodiment, the processor 32 functions as a model matching execution unit 50 (FIG. 11) configured to match a workpiece model 100Mₙ with the shape data SDᵢ of the workpiece 100 detected by the shape detection sensor 14.

In step S6, when the workpiece model 100Mₙ is set to match the shape data SDᵢ in the most recent step S5, the processor 32 obtains a frequency α at which the feature model included in the workpiece model 100Mₙ is consistent with the features appearing in the shape data SDᵢ. For example, the processor 32 is assumed to match the workpiece model 100M₁ at the first orientation OR₁ with the shape data SD₁ appearing in the detection data DD illustrated in FIG. 6 in the most recent step S5.

In this case, all the feature models such as the main body model 102M, the shaft model 104M (the side surface model 108M and the end surface model 110M), and the protrusion model 106M included in the workpiece model 100M₁ are consistent with the features (i.e., the features of the main body 102, the shaft 104, and the protrusion 106 of the workpiece 100) appearing in the shape data SD₁.

For example, the processor 32 obtains a matching degree β between a feature point Fm constituting the feature model of the workpiece model 100M₁ to which an identification code ID is assigned and a feature point Fs constituting the feature appearing in the shape data SDᵢ. The matching degree β includes an error in distance between, for example, the feature point Fm and the feature point Fs corresponding to the feature point Fm. In this case, as the feature point Fm and the feature point Fs are highly accurately consistent with each other, the value of the matching degree β becomes smaller.

Alternatively, the matching degree β includes a similarity degree representing similarity between the feature points Fm and the feature points Fs corresponding to the feature points Fm. In this case, as the feature point Fm and the feature point Fs are highly accurately consistent with each other, the value of the matching degree β becomes smaller. The processor 32 can determine whether or not the respective feature models (the main body model 102M, the side surface model 108M, the end surface model 110M, and the protrusion model 106M) of the workpiece model 100M₁ are consistent with the features (the main body 102, the side surface 108, the end surface 110, and the protrusion 106) appearing in the shape data SD₁ by comparing the obtained matching degree β with a predetermined threshold value βₜₕ₁ of the matching degree β.

For example, the processor 32 determines that the feature model of the workpiece model 100M₁ is consistent with the feature of the shape data SD₁ when the matching degree β is greater than the threshold value βₜₕ₁ (β>βₜₕ₁ or β<βₜₕ₁). As a result of this determination, the processor 32 can detect that all the feature models of the workpiece model 100M₁ are consistent with the features of the shape data SD₁. Then, the processor 32 increases the frequency α by “1” (α=α+1) for each of the main body model 102M, the side surface model 108M, the end surface model 110M, and the protrusion model 106M.

That is, in the present embodiment, the frequency α indicates the number of times in which the feature model of the workpiece model 100Mₙ is consistent with the feature appearing in the shape data SDᵢ when the workpiece model 100Mₙ is caused to match the shape data SDᵢ. The processor 32 stores the frequency α counted for each of the feature models of the workpiece model 100Mₙ in step S6 in the memory 34 in association with the identification codes ID assigned to the feature models. Note that the frequency α is not limited to the above-described number of times of matching, and may be obtained by, for example, adding a weighting operation according to the matched feature model or the matching degree β to the number of times of matching, or may be obtained by any method.

For example, the processor 32 is assumed to match the workpiece model 100M₁ at the first orientation OR₁ with the shape data SD₂ appearing illustrated in FIG. 7 in the most recent step S5. In this case, as illustrated in FIG. 8(c), the feature models such as the main body model 102M and the protrusion model 106M included in the workpiece model 100M₁ are consistent with the features such as the main body 102 and the protrusion 106 of the workpiece 100 appearing in the shape data SD₂. Therefore, in this case, the processor 32 increases the frequency α by “1” (α=α+1) for the main body model 102M and the protrusion model 106M included in the workpiece model 100M₁.

On the other hand, the shaft model 104M of the workpiece model 100M₁ (i.e., the side surface model 108M and the end surface model 110M) is not consistent with the features of the workpiece 100 appearing in the shape data SD₂. Therefore, in this case, the processor 32 does not increase the frequency α for the side surface model 108M and the end surface model 110M of the workpiece model 100M₁.

In that manner, when the workpiece model 100Mₙ is set to match the shape data SDᵢ in the most recent step S5, the processor 32 obtains a frequency α at which the feature model included in the workpiece model 100Mₙ is consistent with the features appearing in the shape data SDᵢ. Thus, the processor 32 functions as a frequency calculation unit 52 (FIG. 11) that obtains a frequency α.

In step S7, the processor 32 determines whether or not the workpiece model 100Mₙ (when n is set to 1, the workpiece model 100M₁ at the first orientation OR₁) is caused to match all the pieces of the shape data SDᵢ appearing in the detection data DD acquired in step S3.

The processor 32 proceeds to step S8 when the answer to the determination is YES, and returns to step S5 when the answer to the determination is NO. In this way, the processor 32 repeatedly executes the loop from step S5 to step S7 until the answer to the determination is YES in step S7, obtains the frequency α for each feature model of the workpiece model 100Mₙ every time the workpiece model 100Mₙ matches the shape data SDᵢ appearing in the detection data DD, and updates the frequency α stored in the memory 34 in association with the identification codes ID assigned to the feature models.

In step S8, the processor 32 determines whether or not each of the plurality of feature models included in the workpiece model 100Mₙ has a dissimilarity relationship with the features appearing in the shape data SDᵢ matched in step S5 based on the frequency α obtained for the feature models. For example, when n=1 is set at the start of step S8, the processor 32 compares the frequency α obtained for the respective feature models (the main body model 102M, the side surface model 108M, the end surface model 110M, and the protrusion model 106M) of the workpiece model 100M₁ with predetermined threshold value αₜₕ₁ every time step S6 is executed.

Then, when the frequency α of one feature model (e.g., the end surface model 110M) is equal to or less than the threshold value αₜₕ₁ (α≤αₜₕ₁), the processor 32 determines that the one feature model is in a dissimilarity relationship with the feature of the shape data SDᵢ. As described above, in the present embodiment, the processor 32 functions as a similarity determination unit 54 (FIG. 11) configured to determine whether or not a feature model is in a dissimilarity relationship with the feature appearing in the shape data SDᵢ based on the frequency α.

When it is determined that at least one feature model included in the workpiece model 100M₁ is in the dissimilarity relationship (i.e., YES), the processor 32 proceeds to step S9, and on the other hand, when it is determined that none of the feature models included in the workpiece model 100M₁ is in the dissimilarity relationship (i.e., NO), the processor 32 proceeds to step S10.

In step S9, the processor 32 functions as the information acquisition unit 46 to acquire the dissimilarity information NI for the feature model determined to have the dissimilarity relationship in the immediately preceding step S8 among the plurality of feature models included in the workpiece model 100Mₙ. For example, it is assumed that n=1 is set at the start of step S9, and as a result of step S8, it is assumed to be determined that the end surface model 110M (FIG. 8(c)) and the protrusion model 106M (FIG. 10(c)) included in the workpiece model 100M₁ at the first orientation OR₁ have a dissimilarity relationship with the feature of the workpiece 100 at the second orientation OR₂ and the feature of the workpiece 100 at the third orientation OR₃, respectively.

In this case, the processor 32 acquires dissimilarity information NI_{1_2} for identifying the end surface model 110M and dissimilarity information NI_{1_3} for identifying the protrusion model 106M among the plurality of feature models (the main body model 102M, the side surface model 108M, the end surface model 110M, and the protrusion model 106M) included in the workpiece model 100M₁ at the first orientation OR₁.

The processor 32 acquires the dissimilarity information NI_{1_2} of the end surface model 110M in association with the identification code ID assigned to the end surface model 110M, and acquires the dissimilarity information NI_{1_3} of the protrusion model 106M in association with the identification code ID assigned to the protrusion model 106M.

Then, the processor 32 stores the acquired dissimilarity information NI_{1_2} and NI_{1_3} in the memory 34 in association with the respective identification codes ID. As a result, the identification codes ID of the feature models of the workpiece model 100M₁ and the dissimilarity information NI_{1_2} and NI_{1_3} of the feature models are associated with each other and stored in the memory 34.

In step S10, the processor 32 determines whether or not the number “n” specifying the orientation ORₙ of the workpiece model 100Mₙ has reached a maximum value n_{MAX} (n=n_{MAX}). The maximum value n_{MAX} indicates the total number of the workpiece models 100Mₙ acquired in step S1 (i.e., the total number of the orientations ORₙ) (e.g., n_{MAX}=500). The processor 32 ends the flow shown in FIG. 12 when the answer to the determination is YES and proceeds to step S11 when the answer to the determination is NO.

In step S11, the processor 32 increases the number “n” for specifying the orientation ORₙ of the workpiece model 100Mₙ by “1” (n=n+1). Then, the processor 32 returns to step S5. Thus, the processor 32 repeatedly performs the loop from step S5 to step S11 until the answer to the determination becomes YES in step S10, and the determination of the dissimilarity relationship (step S8) and the acquisition of the dissimilarity information NI (step S9) are executed for all the workpiece models 100Mₙ acquired in step S1.

As described above, in the present embodiment, the processor 32 functions as the model acquisition unit 44, the information acquisition unit 46, the feature extraction unit 48, the model matching execution unit 50, the frequency calculation unit 52, and the similarity determination unit 54, and acquires the dissimilarity information NI of the workpiece models 100Mₙ. Therefore, the model acquisition unit 44, the information acquisition unit 46, the feature extraction unit 48, the model matching execution unit 50, the frequency calculation unit 52, and the similarity determination unit 54 constitute a device 82 (FIG. 11) for acquiring the dissimilarity information NI.

The feature extraction unit 48 of the device 82 extracts a plurality of feature models included in the workpiece models 100Mₙ from each of the workpiece models 100Mₙ, and assigns identification codes ID to the extracted feature models, respectively (step S2). Then, the information acquisition unit 46 acquires the dissimilarity information NI_{1_2} or NI_{1_3} in association with the identification codes ID assigned to the feature models (e.g., the end surface model 110M or the protrusion model 106M) (step S9).

According to this configuration, the processor 32 can quickly recognize which feature model among the plurality of feature models included in the workpiece models 100Mₙ is in the dissimilarity relationship from the identification codes ID and the dissimilarity information NI associated with each other. Furthermore, the dissimilarity information NI can be accumulated for each feature model classified by the identification codes ID.

In addition, the model matching execution unit 50 of the device 82 matches the workpiece models 100Mₙ with the shape data SDᵢ of the workpiece 100 detected by the shape detection sensor 14 (step S5). In addition, when the model matching execution unit 50 matches the workpiece models 100Mₙ (e.g., the workpiece model 100M₁) with the shape data SDᵢ (e.g., the shape data SD₁, SD₂, and SD₃ in FIG. 6) of the plurality of orientations ORᵢ, the frequency calculation unit 52 calculates the frequency α at which the feature models included in the workpiece models 100Mₙ are consistent with the features appearing in each piece of the shape data SDᵢ (step S6).

In addition, the similarity determination unit 54 determines whether or not the respective feature models are in a dissimilarity relationship based on the frequency α obtained for the plurality of feature models included in the workpiece models 100Mₙ by the frequency calculation unit 52 (step S8). Then, the information acquisition unit 46 acquires the dissimilarity information with respect to the feature model (e.g., the end surface model 110M or the protrusion model 106M) determined to have the dissimilarity relationship by the similarity determination unit 54 among the plurality of feature models included in the workpiece models 100Mₙ (step S9). According to this configuration, whether or not the feature models of the workpiece models 100Mₙ have the dissimilarity relationship with the features of the workpiece 100 can be determined with high accuracy based on the frequency α, and thus the dissimilarity information NI can be acquired with high accuracy for each feature model.

In addition, when the frequency α calculated by the frequency calculation unit 52 is equal to or less than the predetermined threshold value αₜₕ₁, the similarity determination unit 54 of the device 82 determines that the feature models of the workpiece models 100Mₙ have a dissimilarity relationship with the features of the workpiece 100 (to be specific, the shape data SDᵢ). According to this configuration, a dissimilarity relationship can be determined with high accuracy based on a relatively simple algorithm.

In addition, in an example of the device 82, the model matching execution unit 50 executes matching of the workpiece models 100Mₙ by using the shape data SDᵢ obtained by actually imaging the workpiece 100 by using the shape detection sensor 14 in the real space (step S2). According to this configuration, matching is tried based on the shape data SDᵢ obtained from detection by the shape detection sensor 14 that is an actual machine, and as a result, the dissimilarity information NI can be acquired with high accuracy.

On the other hand, in another example of the device 82, the model matching execution unit 50 executes matching by using the shape data SDᵢ acquired from the simulation SL in which the shape detection sensor 14 simulatively images the workpiece 100 in a virtual space (step S2). According to this configuration, since matching can be easily tried in various ways, the work of acquiring the dissimilarity information NI can be simplified.

Note that, in the above-described step S6, when it is detected that all the feature models of the workpiece models 100Mₙ matched in the immediately preceding step S5 are consistent with the features of the shape data SDᵢ, the processor 32 may not increase the frequency α of each of all the feature models.

For example, when the workpiece model 100M₁ at the first orientation OR₁ is caused to match the shape data SD₁ appearing in the detection data DD illustrated in FIG. 6 in the immediately preceding step S5, the processor 32 can detect that all the feature models of the workpiece model 100M₁ are consistent with the features of the shape data SD₁ as described above. In this case, the processor 32 does not increase the frequency α for each of the main body model 102M, the side surface model 108M, the end surface model 110M, and the protrusion model 106M of the workpiece model 100M₁.

That is, in this case, when the workpiece models 100Mₙ are caused to match the shape data SDᵢ at the same orientation ORₙ (i.e., appropriate matching), the processor 32 excludes the feature model consistent with the features of the shape data SDᵢ from the calculation target of the frequency α. This makes it possible to more efficiently acquire the dissimilarity information NI for detecting inappropriate matching.

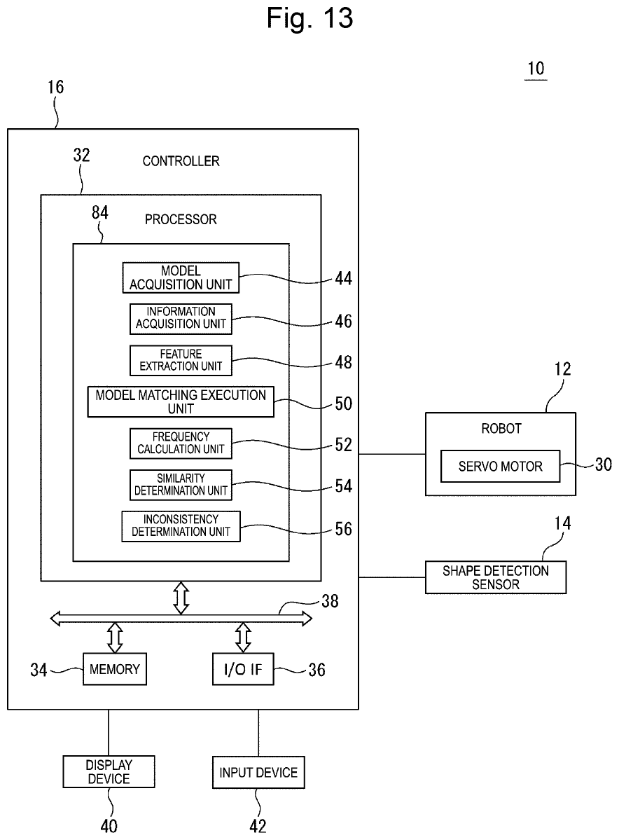

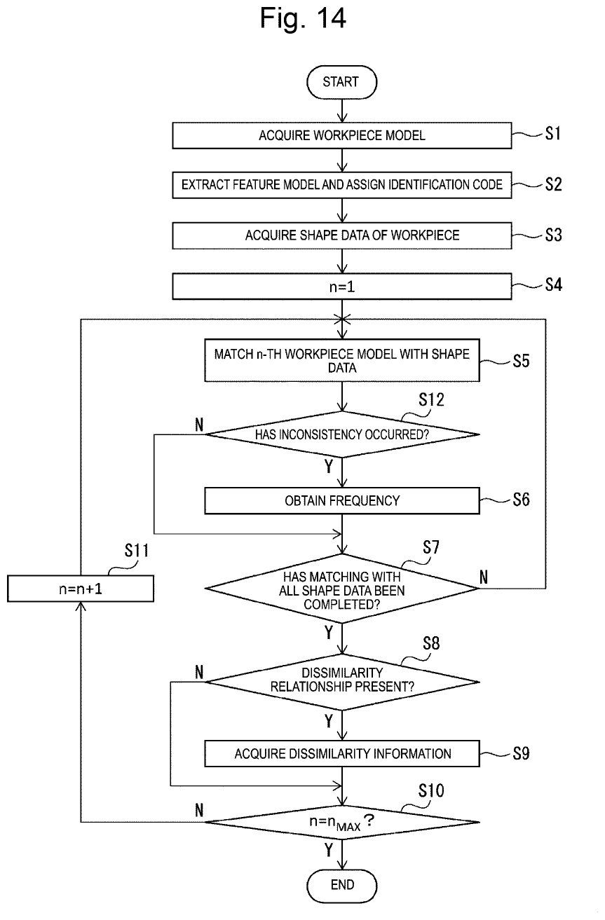

Next, yet another function of the robot system 10 will be described with reference to FIG. 13. The robot system 10 illustrated in FIG. 13 executes the flow shown in FIG. 14. Although the flow shown in FIG. 14 is a flow for acquiring the dissimilarity information NI as in the flow of FIG. 12, it is different from the flow of FIG. 12 in step S12.

To be specific, after step S5, the processor 32 determines in step S12 whether or not there is a mismatch between at least one feature model included in the workpiece models 100Mₙ and the features appearing in the shape data SDᵢ when the matching of the workpiece models 100Mₙ is executed in the most recent step S5.

For example, it is assumed that the workpiece model 100M₁ at the first orientation OR₁ is set to match the shape data SD₂ appearing in the detection data DD of FIG. 6 in the immediately preceding step S5. In this case, for example, the processor 32 obtains the matching degree β between the feature point Fm constituting each feature model (the main body model 102M, the side surface model 108M, the end surface model 110M, and the protrusion model 106M) of the workpiece model 100M₁ to which the identification code ID is assigned and the feature point Fs constituting the feature appearing in the shape data SD₂.

Then, the processor 32 compares the matching degree β obtained for each of the feature models to which the identification codes ID are assigned with a threshold value βₜₕ₁, and when the matching degree β does not exceed the threshold value βₜₕ₁, the processor 32 determines that a mismatch occurs between the feature model of the workpiece model 100M₁ and the feature of the shape data SD₂ (i.e., YES). As a result of this determination, the processor 32 determines that the side surface model 108M and the end surface model 110M (i.e., the shaft model 104M) of the workpiece model 100M₁ are not consistent with the features of the shape data SD₂ as illustrated in FIG. 8(c).

When it is determined to be YES, the processor 32 proceeds to step S6, and obtains the frequency α at which the feature models (the main body model 102M and the protrusion model 106M of FIG. 8(c)) included in the workpiece model 100M₁ are consistent with the features (the features of the main body 102 and the protrusion 106) appearing in the shape data SDᵢ. On the other hand, when it is determined to be NO, the processor 32 proceeds to step S7.

As described above, in the present embodiment, the processor 32 functions as an inconsistency determination unit 56 (FIG. 13) which determines whether or not an inconsistency has occurred between the feature models included in the workpiece models 100Mₙ and the features appearing in the shape data SDᵢ when the matching is executed using the workpiece models 100Mₙ in step S5.

As described above, in the present embodiment, the processor 32 functions as the model acquisition unit 44, the information acquisition unit 46, the feature extraction unit 48, the model matching execution unit 50, the frequency calculation unit 52, the similarity determination unit 54, and the inconsistency determination unit 56 to acquire the dissimilarity information NI of the workpiece models 100Mₙ. Therefore, the model acquisition unit 44, the information acquisition unit 46, the feature extraction unit 48, the model matching execution unit 50, the frequency calculation unit 52, the similarity determination unit 54, and the inconsistency determination unit 56 constitute a device 84 (FIG. 11) for acquiring the dissimilarity information NI.

When the model matching execution unit 50 of the device 84 executes matching using a workpiece model 100Mₙ (e.g., the workpiece model 100M₁) (step S5), the inconsistency determination unit 56 determines whether or not there is an inconsistency between at least one feature model (e.g., the side surface model 108M and the end surface model 110M) included in the workpiece model 100Mₙ and a feature corresponding to the at least one feature model appearing in shape data SDᵢ (e.g., the shape data SD₂) (step S12).

In addition, when the inconsistency determination unit 56 determines that there is an inconsistency (i.e., YES in step S12), the frequency calculation unit S6 calculates the frequency α at which a feature model other than the at least one feature model (e.g., the main body 102 and the protrusion 106) is consistent with the feature of the shape data SDᵢ (e.g., the shape data SD₂) (step S6).

According to this configuration, when an inconsistency has occurred in matching between a workpiece model 100Mₙ and shape data SDᵢ, the frequency α can be obtained only for the feature model that is consistent with the feature of the shape data SDᵢ. Here, the feature model determined to be inconsistent in step S12 is highly likely to have the above-described dissimilarity relationship. Therefore, by collecting the frequency α obtained when it is determined in step S12 that an inconsistency has occurred, the dissimilarity information NI can be efficiently acquired in step S9.

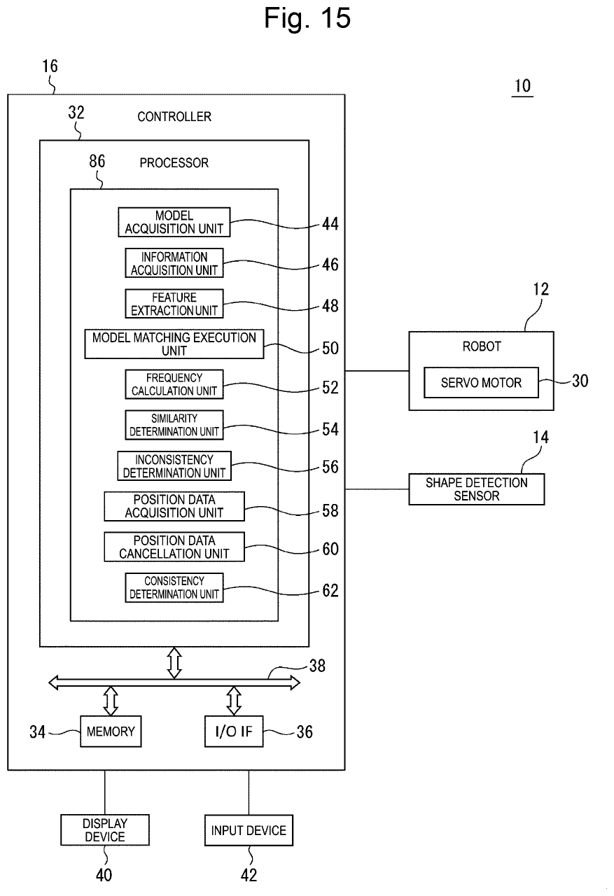

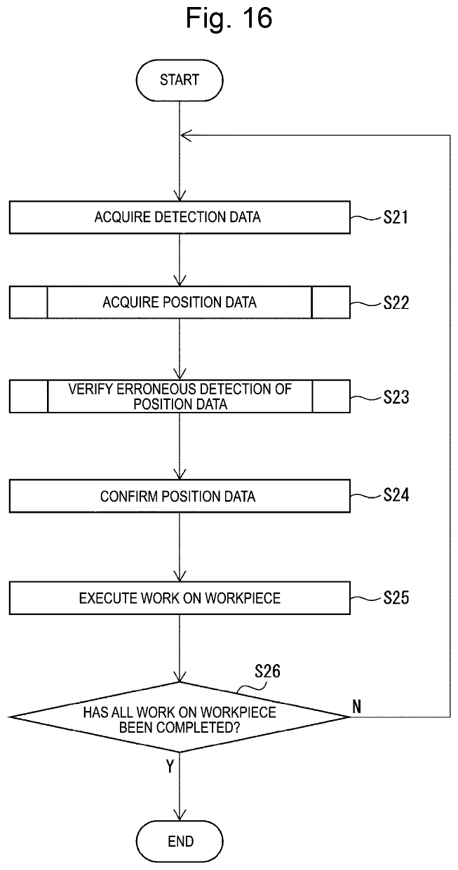

Next, yet another function of the robot system 10 will be described with reference to FIG. 15. The robot system 10 illustrated in FIG. 15 executes the flow shown in FIG. 16. The flow of FIG. 16 is a flow for causing the robot 12 to perform predetermined work on the workpieces 100 piled in bulk in the container B, and is performed after execution of the flow of FIG. 12 or 14 (i.e., after acquisition of the dissimilarity information NI). The processor 32 starts the flow of FIG. 16 upon receiving a work start command from an operator, an upper controller, or a computer program PG after execution of the flow of FIG. 12 or 14.

In step S21, the processor 32 acquires the detection data DD detected by the shape detection sensor 14. Specifically, the processor 32 operates the robot 12 to position the shape detection sensor 14 at an imaging position at which the workpieces 100 piled in bulk in the container B fall within the detection range of the shape detection sensor 14. Then, the processor 32 operates the shape detection sensor 14 to image the workpieces 100 in the container B, thereby detecting the detection data DD as illustrated in FIG. 6. The processor 32 acquires the detected detection data DD from the shape detection sensor 14.

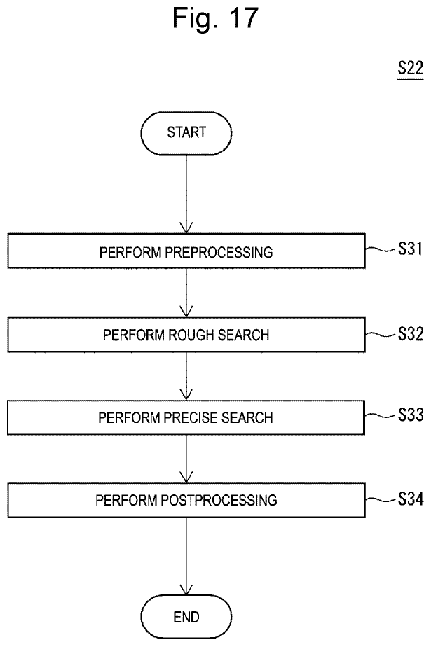

In step S22, the processor 32 acquires position data PD of the workpieces 100 in the control coordinate system C by matching the workpiece models 100Mₙ with the shape data SDᵢ appearing in the detection data DD detected by the shape detection sensor 14. That is, in the present embodiment, the processor 32 functions as a position data acquisition unit 58 (FIG. 15) configured to acquire position data PD of the workpieces 100. This step S22 will be described with reference to FIG. 17. The processor 32 functions as the position data acquisition unit 58 and executes the flow of step S22 shown in FIG. 17.

After step S22 starts, in step S31, the processor 32 executes preprocessing PP on the detection data DD acquired in the most recent step S21. For example, as the preprocessing PP, the processor 32 may execute processing of deleting a point group to be invalidated (e.g., a point group existing outside the container B or a point group greatly deviating from the point group of the shape data SDᵢ of the workpiece 100 by more than a predetermined distance) from the detection data DD among the point groups included in the detection data DD.

In step S32, the processor 32 performs rough search RS based on a predetermined matching algorithm. In detail, as the rough search RS, the processor 32 sequentially arranges a plurality of workpiece models 100Mₙ acquired in the above-described step S1 in a virtual space defined by the sensor coordinate system C3 of the detection data DD, and matches the workpiece models 100Mₙ with the respective piece of shape data SDᵢ included in the detection data DD. That is, in the present embodiment, the processor 32 matches each of the plurality of workpiece models 100Mₙ with one piece of shape data SDᵢ included in the detection data DD.

At this time, the processor 32 repeatedly displaces the position of the workpiece models 100Mₙ arranged in the sensor coordinate system C3 by a predetermined displacement amount. Then, every time the positions of the workpiece models 100Mₙ are displaced, the processor 32 obtains a matching degree β between feature points Fm of the workpiece models 100Mₙ and feature points Fs of the shape data SDᵢ.

Then, the processor 32 compares the obtained matching degree β with a threshold value βₜₕ₂, and when the matching degree β exceeds the threshold value βₜₕ₂ (i.e., β>βₜₕ₂ or β<βₜₕ₂), the processor determines that, in the sensor coordinate system C3, the workpiece models 100Mₙ approximately match the shape data SDᵢ. Note that, the threshold value βₜₕ₂ may be the same value as the above-described threshold value βₜₕ₁, or may be a different value.

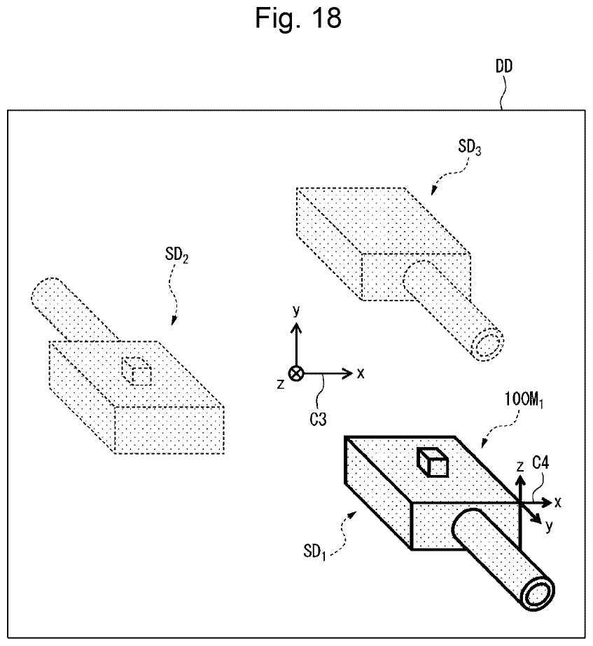

FIG. 18 illustrates a state in which the workpiece model 100M₁ at the first orientation OR₁ is matched with the shape data SD₁. The processor 32 acquires, as a sensor coordinate system position data PD_{0_1}, the coordinates Q1s (X1s, Y1s, Z1s, W1s, P1s, R1s) in the sensor coordinate system C3 of the workpiece coordinate system C4 set in the workpiece model 100M₁ matched with the shape data SD₁ as the rough search RS.

Here, in the sensor coordinate system position data PD_{0_1} (i.e., the coordinates Q1s), coordinates (X1s, Y1s, Z1s) indicate the position of the origin of the workpiece coordinate system C4 in the sensor coordinate system C3, and coordinates (W1s, P1s, R1s) indicate the orientations (so-called yaw, pitch, and roll) in the workpiece coordinate system C4 in the sensor coordinate system C3.

Then, the processor 32 converts the sensor coordinate system position data PD_{0_1} into the coordinates Q1_{R} (X1_{R}, Y1_{R}, Z1_{R}, W1_{R}, P1_{R}, R1_{R}) in the robot coordinate system C1, and acquires the coordinates Q1_{R} as initial position data PD_{1_1}. The initial position data PD_{1_1} indicates approximate values of the position and orientation of the workpiece 100 detected by the shape detection sensor 14 in the robot coordinate system C1 as the shape data SD₁.

Similarly, the processor 32 sequentially acquires the sensor coordinate system position data PD_{0_}i and the initial position data PD_{1_}i of the other shape data SDᵢ appearing in the detection data DD. In this way, the processor 32 acquires the position data PD_{0_}i and PD_{1_}i of the workpiece 100 by matching the workpiece model 100Mₙ with the shape data SDᵢ in the rough search RS.

In step S33, the processor 32 performs precise search PS. Specifically, with respect to the initial position data P0_{1_}i acquired in step S32 for the shape data SDᵢ appearing in the detection data DD, the processor 32 searches for a position at which the workpiece model 100Mₙ highly matches the shape data SDᵢ in the sensor coordinate system C3 based on a predetermined matching algorithm (e.g., a mathematical optimization algorithm such as Iterative Closest Point (ICP)).

For example, the processor 32 obtains a matching degree γ between the point group of the point group model 100MPₙ arranged as the workpiece model 100Mₙ in the initial position data PD_{1_}i of the sensor coordinate system C3 and the three-dimensional point group of the shape data SDᵢ included in the detection data DD. For example, this matching degree γ includes an error in distance between the point group of the point group model 100Mpₙ and the three-dimensional point group of the shape data SDᵢ, or a similarity degree between the point group of the point group model 100Mpₙ and the three-dimensional point group of the shape data SDᵢ.

Then, the processor 32 compares the obtained matching degree γ with a predetermined threshold value γₜₕ with respect to the matching degree γ, and when the matching degree γ exceeds the threshold value γₜₕ (i.e., γ>γₜₕ, or γ<γₜₕ), the processor determines that the workpiece model 100Mₙ (e.g., the point group model 100Mpₙ) and the shape data SDᵢ match precisely in the sensor coordinate system C3. On the other hand, when the matching degree γ does not exceed the threshold value γₜₕ, the processor 32 displaces the position of the workpiece model 100Mₙ arranged in the sensor coordinate system C3 by a predetermined displacement amount, obtains the matching degree γ every time the position of the workpiece model 100Mₙ is displaced, and compares the matching degree γ with the threshold values γₜₕ.

When the matching degree γ exceeds the threshold value γₜₕ, the processor 32 acquires coordinates Q2s (X2s, Y2s, Z2s, W2s, P2s, R2s) in the sensor coordinate system C3 of the workpiece coordinate system C4 set in the workpiece model 100Mₙ matched with the shape data SDᵢ with high accuracy in precise search PS as a sensor coordinate system position data PD_{2_}i.

Then, the processor 32 converts the sensor coordinate system position data PD_{2_}i into coordinates Q2_{R} (X2_{R}, Y2_{R}, Z2_{R}, W2_{R}, P2_{R}, R2_{R}) in the robot coordinate system C1, and acquires the coordinates Q2_{R} as position data PD_{3_}i of the workpiece 100 detected as the shape data SDᵢ. The position data PD_{3_}i represents a highly accurate position and orientation of the workpiece 100 in the robot coordinate system C1. In this way, the processor 32 acquires the position data PD_{2_}i and PD_{3_}i of the workpiece 100 by matching the workpiece model 100Mₙ with the shape data SDᵢ in the precise search PS.

As a result of step S33, the processor 32 acquires each position data PD_{3_}i of the plurality of workpieces 100 appearing in the detection data DD. The processor 32 stores the acquired position data PD_{3_}i as detection result data DT in the memory 34. An example of the data structure of the detection result data DT is schematically shown in Table 1 below.

TABLE 1

| | | | Matching | Plane | Exposure |
|---|---|---|---|---|---|
| Shape Data | Number | Position Data | Degree | Proportion | Rate |
| SD₁ | 1 | PD₃_1 | γ₁ | δ₁ | ε₁ |
| SD₂ | 2 | PD₃_2 | γ₂ | δ₂ | ε₂ |
| . | . | . | . | . | . |
| . | . | . | . | . | . |
| . | . | . | . | . | . |
| SDᵢ | j | PD₃_i | γᵢ | δᵢ | εᵢ |

The detection result data DT shown in Table 1 store detection result parameters PM such as a matching degree γᵢ, a plane proportion δᵢ, and an exposure rate εᵢ together with position data PD_{3_}i of the workpiece 100 (to be specific, the coordinates Q2_{R} (X2_{R}, Y2_{R}, Z2_{R}, W2_{R}, P2_{R}, R2_{R})). The detection result parameters PM are parameters representing the results of matching between the shape data SDᵢ of the workpiece 100 and the workpiece models 100Mₙ executed when the position data PD_{3_}i is acquired. To be specific, a matching degree γᵢ is a matching degree in which it is determined that the workpiece model 100Mₙ is matched with the shape data SDᵢ with high accuracy in the precise search PS of step S33.

A plane proportion δᵢ is, for example, in the workpiece model 100Mₙ matched with the shape data SDᵢ in the precise search PS, a proportion of a maximum plane model (to be specific, a point group model 100Mpₙ of a plane) included in the workpiece model 100Mₙ in the entire workpiece models 100Mₙ (to be specific, the entire point group models 100Mpₙ). Alternatively, the plane proportion δᵢ may be a proportion of a point group representing the maximum plane included in the shape data SDᵢ with which the workpiece model 100Mₙ is matched in the precise search PS with respect to the entire shape data SDᵢ (to be specific, the entire point group).

An exposure rate εᵢ represents, for example, a ratio of a region of the workpiece model 100Mₙ matched with shape data SDᵢ (i.e., a point group of the point group model 100Mpₙ matched with the point group of the shape data SDᵢ) with respect to the entire workpiece models 100Mₙ matched with the shape data SDᵢ in the precise search PS (to be specific, all point groups constituting the point group model 100Mpₙ).

The processor 32 acquires the detection result parameters PM (the matching degree γᵢ, the plane proportion δᵢ, and the exposure rate εᵢ) together with the position data PD_{3_}i, associates the detection result parameters PM with the position data PD_{3_}i, and stores the detection result parameters PM in the memory 34 as the detection result data DT. Note that the detection result parameters PM are not limited to the matching degree γᵢ, the plane proportion δᵢ, and the exposure rate εᵢ, and may include any other parameter.

In addition, in the detection result data DT shown in Table 1, information of the shape data SDᵢ from which the position data PD_{3_}i is acquired and the number j (j=1, 2, 3, . . . ) sequentially given to the acquired position data PD_{3_}i are stored together in association with the position data PD_{3_}i and the detection result parameters PM.

In step S34, the processor 32 executes post-processing OP on the detection result data DT. For example, the processor 32 may execute processing of deleting the position data PD_{3_}i whose detection result parameter PM does not satisfy a predetermined criterion from the detection result data DT as the post-processing OP.

Specifically, when the matching degree γᵢ, the plane proportion δᵢ, or the exposure rate εᵢ does not exceed a predetermined reference value, the processor 32 may determine that the detection result parameter PM does not satisfy the reference and delete the position data PD_{3_}i associated with the detection result parameter PM from the detection result data DT. As described above, the processor 32 functions as the position data acquisition unit 58 to execute step S22 shown in FIG. 17 and acquire the position data PD_{0_}i, PD_{1_}i, PD_{2_}i, and PD_{3_}i of the workpiece 100.

Again, with reference to FIG. 16, in step S23, the processor 32 verifies erroneous detection of the position data PD acquired in step S22. Here, in the above-described steps S32 and S33, as a result that the processor 32 inappropriately matches the workpiece model 100Mₙ with the shape data SDᵢ, there is a possibility that the position data PD_{3_}i will be acquired as illustrated in FIG. 8(c) or 10(c). The position data PD_{3_}i obtained as a result of such inappropriate matching becomes data of erroneous detection that does not accurately represent the position and the orientation of the workpiece 100.

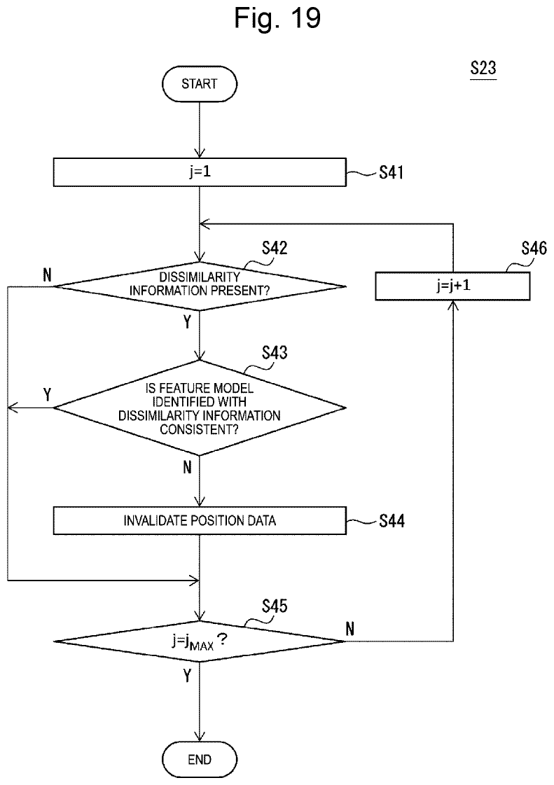

Therefore, in the present embodiment, the processor 32 verifies the erroneous detection of the position data PD_{3_}i stored in the detection result data DT in step S23. Step S23 will be described with reference to FIG. 19. After step S23 is started, the processor 32 sets the number “j” specifying the position data PD_{3_}i stored in the detection result data DT to “1” in step S41.

In step S42, the processor 32 determines whether or not the dissimilarity information NI has been acquired for the workpiece model 100Mₙ used in the matching for acquiring a j-th position data PD_{3_}i. Hereinafter, at this point, a case will be described in which the number “j” of the position data PD is set to j=2 and the second (i.e., the number j=2) position data PD_{3_2} stored in the detection result data DT of Table 1 is obtained as a result of inappropriate matching of the workpiece model 100M₁ at the first orientation OR₁ with the shape data SD₂ as illustrated in FIG. 8(c).

In this case, the processor 32 specifies the workpiece model 100M₁ used for the matching when the second position data PD_{3_2} is acquired, and can recognize that the dissimilarity information NI_{1_2} and NI_{1_3} for identifying the end surface model 110M and the protrusion model 106M have been acquired in the above-described step S9 for the workpiece model 100M₁. Therefore, in this case, the processor 32 determines YES for step S42. The processor 32 proceeds to step S43 when the answer to the determination is YES, and proceeds to step S45 when the answer to the determination is NO.

In step S43, the processor 32 determines whether or not the feature model identified by the dissimilarity information NI among the feature models included in the workpiece model 100Mₙ used to acquire the j-th position data PD_{3_}i is consistent with the feature appearing in the shape data SDᵢ from which the j-th position data PD_{3_}i has been acquired.

To be specific, the processor 32 determines whether or not the end surface model 110M identified by the dissimilarity information NI_{1_2} for the workpiece 100 at the second orientation OR₂ in the workpiece model 100M₁ at the first orientation OR₁ used to acquire the second position data PD_{3_2} is consistent with the feature appearing in the shape data SD₂.

For example, the processor 32 analyzes the matching data when the matching degree γ₂ stored in association with the second position data PD_{3_2} in the detection result data DT was acquired, and acquires the matching degree γ₂′ between the end surface model 110M matched in the above-described step S33 (precise search PS) and the feature of the shape data SD₂.

Then, when the matching degree γ₂′ exceeds a predetermined threshold value γₜₕ′ (γ₂′>γₜₕ′ or γ₂′<γₜₕ′), the processor 32 determines that the end surface model 110M identified by the dissimilarity information NI_{1_2} is consistent with the feature appearing in the shape data SD₂ (i.e., YES).

Note that, the threshold value γₜₕ′ may be the same value as the above-described threshold value γₜₕ, or may be a different value. In the present embodiment, as illustrated in FIG. 8(c), since the end surface model 110M of the workpiece model 100M₁ is inconsistent with the feature of the shape data SD₂, the matching degree γ₂′ does not exceed the threshold value γₜₕ′.

Therefore, in this case, the processor 32 determines that the end surface model 110M identified by the dissimilarity information NI_{1_2} is inconsistent with the feature appearing in the shape data SD₂ (i.e., NO). The processor 32 proceeds to step S44 when the answer to the determination is NO, and proceeds to step S45 when the answer to the determination is YES.

As described above, in the present embodiment, when the position data PD_{3_}i is acquired by matching the workpiece model 100Mₙ with the shape data SDᵢ, the processor 32 functions as a consistency determination unit 62 (FIG. 15) configured to determine whether or not a feature model identified by the dissimilarity information NI is consistent with the feature appearing in the shape data SDᵢ.

Note that the processor 32 may determine in step S43 whether or not the protrusion model 106M identified by the dissimilarity information NI_{1_3} with respect to the workpiece 100 at the third orientation OR₃ (i.e., the shape data SD₃ in FIG. 10(c)) in the workpiece model 100M₁ at the first orientation OR₁ is consistent with the feature appearing in the shape data SD₂.

In this case, the processor 32 functions as the consistency determination unit 62 to determine whether or not the protrusion model 106M is consistent with the feature of the shape data SD₂. As illustrated in FIG. 8(c), the protrusion model 106M of the workpiece model 100M₁ is consistent with the feature (protrusion 106) of the shape data SD₂. Therefore, the processor 32 determines that the protrusion model 106M identified by the dissimilarity information NI_{1_3} is consistent with the feature of the shape data SD₂.

That is, in step S43, when there are a plurality of pieces of dissimilarity information NI in the workpiece model 100Mₙ, the processor 32 determines whether or not each of the plurality of feature models identified by the pieces of dissimilarity information NI is consistent with the feature of the shape data SDᵢ. In addition, when at least one feature model is inconsistent with the feature of the shape data SDᵢ, the processor 32 determines that the answer is NO.

In step S44, the processor 32 invalidates the position data PD of the workpiece 100 acquired in step S22 described above. Here, in the present embodiment, the second position data PD_{3_2} stored in the detection result data DT of Table 1 is obtained as a result of inappropriate matching as illustrated in FIG. 8(c) as described above. In this case, if the processor 32 causes the robot 12 to perform the work on the workpiece 100 using the position data PD_{3_2} obtained as a result of the inconsistency in step S25 to be described below, the work will not be performed with high accuracy.

Therefore, in the present embodiment, the processor 32 invalidates the position data PD_{3_2} in step S44 in order to avoid using the position data PD_{3_2} for the control of step S25 to be described below. As an example, the processor 32 deletes the position data PD_{3_2} from the detection result data DT created in step S22 described above.

As another example, the processor 32 assigns an invalidation flag FL to the position data PD_{3_2} of the workpiece 100 stored in the detection result data DT. In this case, the processor 32 refers to the invalidation flag FL assigned to the position data PD_{3_2} and ignores the position data PD_{3_2} when the processor 32 reads the position data PD_{3_2} of the detection result data DT in executing step S25 to be described below. As a result, the processor 32 cancels the work on the workpiece 100 detected as the shape data SD₂ in step S25.

In this way, the processor 32 invalidates the position data PD_{3_}i stored in the detection result data DT in step S44 (e.g., deletes the position data PD or assigns the invalidation flag FL thereto), thereby making it possible to avoid using the position data PD_{3_}i acquired as a result of the inconsistency in the control of step S25 to be described below.

As described above, in the present embodiment, the processor 32 functions as a position data cancellation unit 60 (FIG. 15) configured to invalidate the position data PD_{3_}i acquired in step S22 when there is an inconsistency between the workpiece model 100Mₙ matched with the shape data SDᵢ in order to acquire the position data PD_{3_}i and the shape data SDᵢ (i.e., it is determined as NO in step S43).

In step S45, the processor 32 determines whether or not the number “j” of the position data PD set at the time point satisfies j=j_{MAX}. This j_{MAX} is the total number of pieces of position data PD_{3_}i acquired in step S22. The processor 32 ends the flow shown in FIG. 19 when the answer to the determination is YES and proceeds to step S46 when the answer to the determination is NO.

In step S46, the processor 32 increases the number “j” of the position data PD_{3_}i by “1” (j=j+1). Then, the processor 32 returns to step S42. In this way, the processor 32 repeatedly executes the loop of steps S42 to S46 until it is determined as YES in step S45, and invalidates the position data PD_{3_}i (e.g., the position data PD_{3_2}) acquired as a result of the inconsistency among the pieces of the position data PD_{3_}i stored in the detection result data DT.

Referring again to FIG. 16, the processor 32 confirms the position data PD_{3_}i in step S24. To be specific, the processor 32 confirms that the detection result date DT after the execution of the above-described step S23 as formal control data used in the control of step S25 to be described below, and stores the control data in the memory 34 (e.g., a RAM).

In step S25, the processor 32 refers to the detection result data D T determined in step S24 and operates the robot 12 to perform work (workpiece handling, welding, laser processing, or the like) on the workpiece 100. It is assumed that the first position data PD_{3_1} is not invalidated but the second position data PD_{3_2} is invalidated in step S44 described above.

In this case, the processor 32 refers to the first position data PD_{3_1} stored in the detection result data DT to operate the robot 12 to position the end effector 28 (i.e., the tool coordinate system C2) at the position and orientation indicated by the position data PD_{3_1} (i.e., the coordinates Q2_{R} of the robot coordinate system C1_{R} (X2_{R}, Y2_{R}, Z2_{R}, W2_{R}, P2_{R}, R2_{R})) and thereby causes the end effector 28 to execute work on the workpiece 100 detected as the shape data SD₁. On the other hand, the processor 32 cancels the work on the workpiece 100 detected as the shape data SD₂ from which the second position data PD_{3_2} was acquired.

In step S26, the processor 32 determines whether or not the work on all the workpieces 100 in the container B has been completed. The processor 32 ends the flow shown in FIG. 16 if the answer to the determination is YES and returns to step S21 if the answer to the determination is NO. In this way, the processor 32 repeatedly executes the loop of steps S21 to S26 until it is determined as YES in step S26, acquires the detection data DD newly detected by the shape detection sensor 14 in step S21, and executes steps S22 to S25 based on the new detection data DD.

As described above, in the present embodiment, the processor 32 functions as the model acquisition unit 44, the information acquisition unit 46, the feature extraction unit 48, the model matching execution unit 50, the frequency calculation unit 52, the similarity determination unit 54, and the cancellation unit 60, and the consistency determination unit 62 to acquire the dissimilarity information NI of the workpiece models 100Mₙ.

Therefore, the model acquisition unit 44, the information acquisition unit 46, the feature extraction unit 48, the model matching execution unit 50, the frequency calculation unit 52, the similarity determination unit 54, the inconsistency determination unit 56, the position data acquisition unit 58, the position data cancellation unit 60, and the consistency determination unit 62 constitute a device 86 (FIG. 15) configured to acquire the dissimilarity information NI.

The position data acquisition unit 58 of the device 86 acquires the position data PD (specifically, the position data PD_{0_}i, PD_{1_}i, PD_{2_}i, and PD_{3_}i) of the workpiece 100 in the control coordinate system C by matching the workpiece models 100Mₙ with the shape data SDᵢ of the workpiece 100 detected by the shape detection sensor 14 disposed at a known position in the control coordinate system C (robot coordinate system C1) (steps S32 and S33).

Then, when there is an inconsistency between the workpiece models 100Mₙ matched with the shape data SDᵢ for the position data acquisition unit 58 to acquire the position data PD and the shape data SDᵢ (i.e., it is determined as NO in step S43), the position data cancellation unit 60 invalidates the position data PD acquired by the position data acquisition unit 58 (Step S44).

According to this configuration, it is possible to avoid causing the robot 12 to perform the work (step S25) on the workpiece 100 by using the position data PD_{3_}i acquired as a result of the inappropriate matching as illustrated in FIG. 8(c) or 10(c), for example. Accordingly, it is possible to improve the accuracy of the work performed by the robot 12 in step S25.

In addition, when the position data acquisition unit 58 of the device 86 acquires the position data PD (PD_{3_2}) by matching the workpiece model 100Mₙ (e.g., the workpiece model 100M₁) with the shape data SDᵢ (e.g., the shape data SD₂), the consistency determination unit 62 determines whether or not the feature model (end surface model 110M) identified by the dissimilarity information NI (NI_{1_2}) is consistent with the feature appearing in the shape data SDᵢ (step S43).

When the consistency determination unit 62 determines that the feature model (110M) is not consistent with the feature of the shape data SDᵢ (NO in step S43), the position data cancellation unit 60 invalidates the position data PD (PD_{3_2}) acquired by the position data acquisition unit 58. According to this configuration, it is possible to verify whether or not inappropriate matching has occurred at the time of acquisition of the position data PD by paying attention to the feature model identified by the dissimilarity information NI. Thus, erroneous detection of the position data PD can be found with high accuracy.

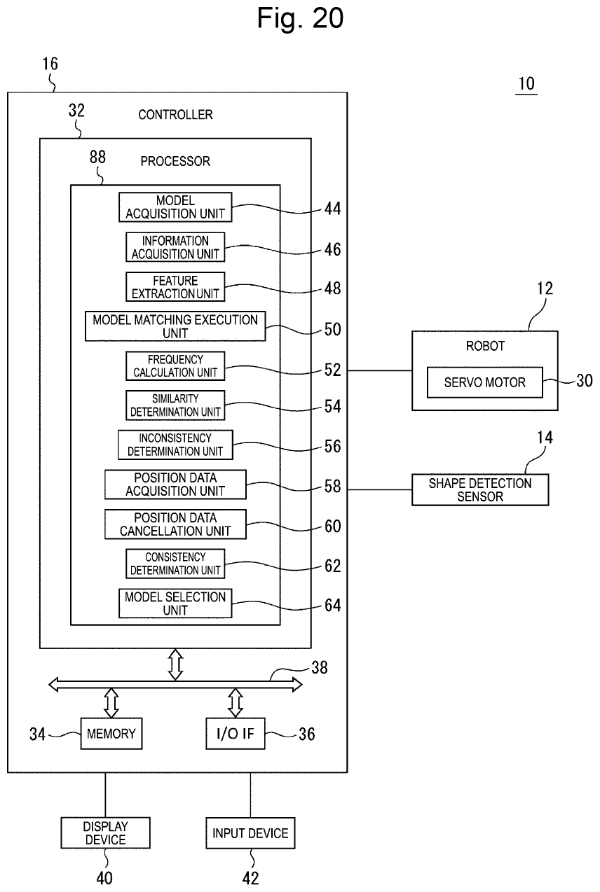

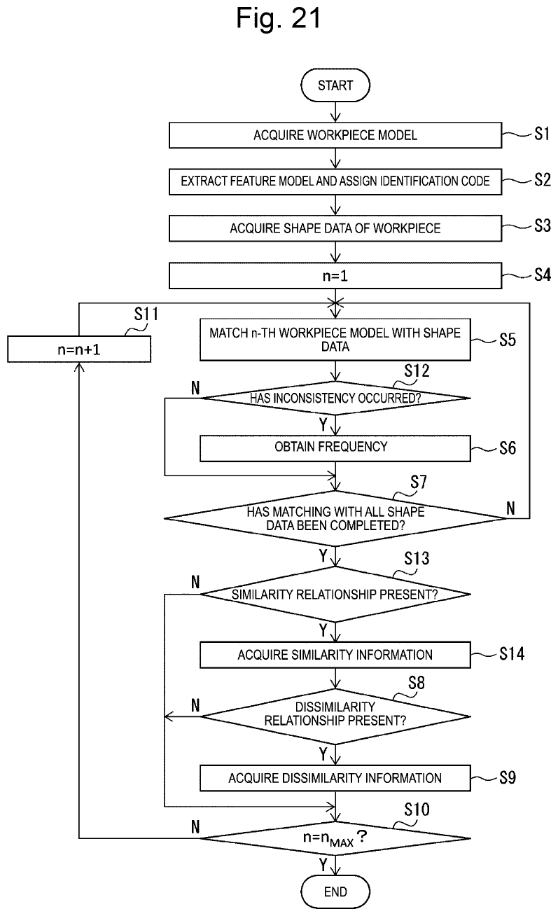

Next, yet another function of the robot system 10 will be described with reference to FIG. 20. The robot system 10 illustrated in FIG. 20 executes the flow shown in FIG. 21. Note that, in the flow shown in FIG. 21, the same processes as those in the flow in FIG. 14 are denoted by the same step numbers, and overlapping descriptions are omitted.

When it is determined as YES in step S7 in the flow of FIG. 21, the processor 32 determines whether or not each of a plurality of feature model included in the workpiece models 100Mₙ has a similarity relationship with the features appearing in the shape data SDᵢ matched in step S5 based on the frequency α obtained for the feature models in step S13.

To be specific, the processor 32 compares the frequency α obtained for each of the feature models (e.g., the main body model 102M, the side surface model 108M, the end surface model 110M, and the protrusion model 106M) of the workpiece models 100Mₙ with a predetermined threshold value αₜₕ₂ every time the above-described step S6 is executed.

Then, when the frequency α of one feature model is equal to or greater than the threshold value αₜₕ₂ (α≥αₜₕ₂), the processor 32 determines that the one feature model has a similarity relationship with the feature of the shape data SDᵢ. The threshold value αₜₕ₂ is set to a value greater than the above-described threshold value αₜₕ₁. The processor 32 determines YES if at least one feature model included in the workpiece models 100Mₙ has a similarity relationship with the feature of the shape data SDᵢ, and proceeds to step S14. On the other hand, the processor 32 determines NO if none of the feature models included in the workpiece models 100Mₙ has a similarity relationship with the feature of the shape data SDᵢ, and proceeds to step S14.

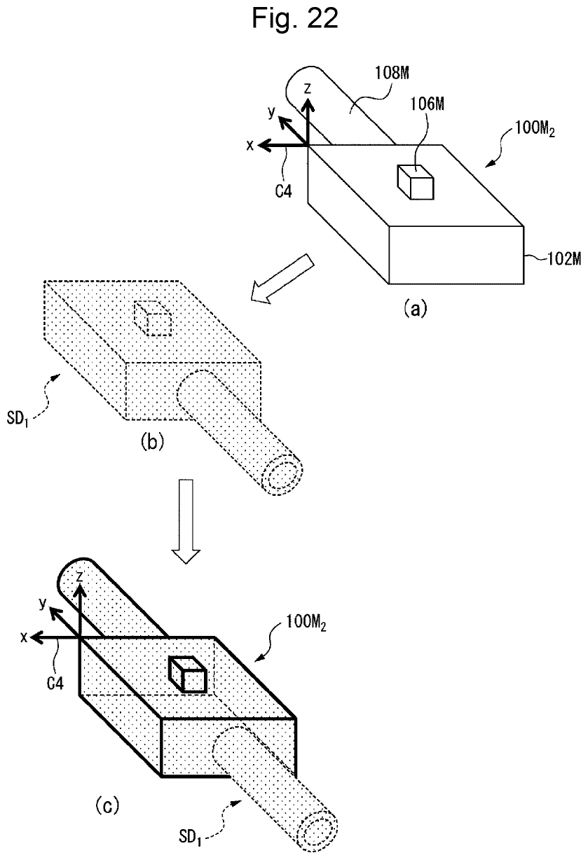

In step S14, the processor 32 functions as the information acquisition unit 46 to acquire similarity information SI for the feature model determined to have the similarity relationship in the immediately preceding step S13 among the plurality of feature models included in the workpiece models 100Mₙ. For example, it is assumed in the immediately preceding step S13 that, with respect to the workpiece model 100M₂ at the second orientation OR₂ (in other words, the number “n”=2) illustrated in FIG. 22(a), the main body model 102M of the workpiece model 100M₂ is determined to have a similarity relationship with the shape data SDᵢ representing the main body 102 of the workpiece 100 at the first orientation OR₁ illustrated in FIG. 22(b).

In this case, the processor 32 acquires similarity information SI_{2_1} for identifying that the main body model 102M included in the workpiece model 100M₂ at the second orientation OR₂ has a similarity relationship with the main body 102 of the workpiece 100 at the first orientation OR₁. Here, in the present embodiment, the similarity information SI_{2_1} includes association information I_{2_1} in which the main body model 102M of the workpiece model 100M₂ at the second orientation OR₂ is associated with the main body model 102M of the workpiece model 100M₁ at the first orientation OR₁ as a similarity relationship.

As an example, the operator visually checks the matching result of the workpiece model 100M₂ and the shape data SD₁ in step S5 displayed on the display device 40, and thereby recognizes that the main body model 102M of the workpiece model 100M₂ at the second orientation OR₂ has a similarity relationship with the main body model 102M of the workpiece model 100M₁ at the first orientation OR₁. Then, the operator may operate the input device 42 to manually input the above-described association information I_{2_1} to the processor 32.

As another example, when the most recent step S5 is executed based on the detection data DD obtained by executing the above-described simulation SL in step S3, the processor 32 can also automatically acquire the association information I_{2_1} from the matching result in step S5. Since the position and the orientation of the workpiece 100 (e.g., the workpiece model 100M) arranged in the virtual space are known in the simulation SL, the processor 32 can automatically recognize that the main body model 102M of the workpiece model 100M₂ at the second orientation OR₂ and the main body model 102M of the workpiece model 100M₁ at the first orientation OR₁ have a similarity relationship.

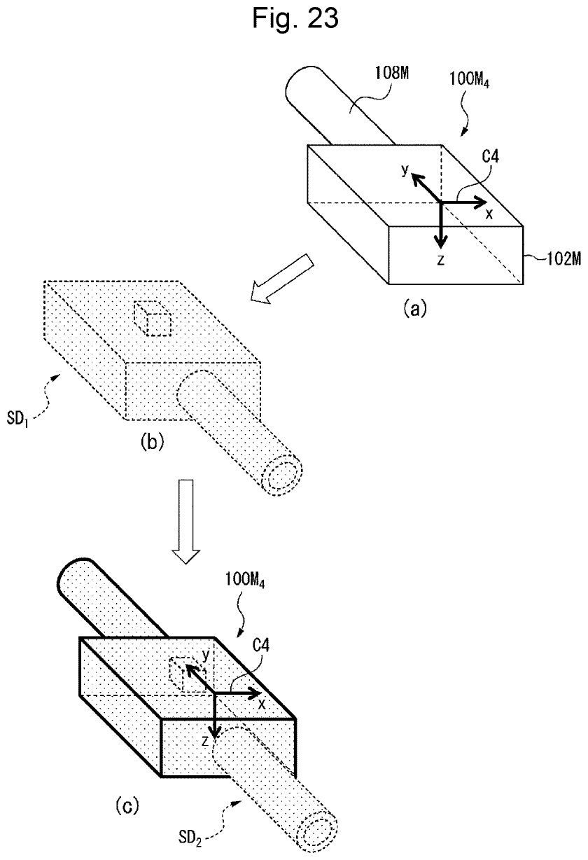

On the other hand, it is assumed in the immediately preceding step S13 that, with respect to the workpiece model 100M₄ at a fourth orientation OR₄ (in other words, the number “n”=4) illustrated in FIG. 23(a), the main body model 102M of the workpiece model 100M₄ is determined to have a similarity relationship with the shape data SDᵢ representing the main body 102 of the workpiece 100 at the first orientation OR₁ illustrated in FIG. 23(b).

In this case, the processor 32 acquires similarity information SI_{4_1} for identifying that the main body model 102M included in the workpiece model 100M₄ at the fourth orientation OR₄ has a similarity relationship with the main body 102 of the workpiece 100 at the first orientation OR₁. The similarity information SI_{4_1} includes association information I_{4_1} in which the main body model 102M of the workpiece model 100M₄ at the fourth orientation OR₄ is associated with the main body model 102M of the workpiece model 100M₁ at the first orientation OR₁ as a similarity relationship. After step S14, the processor 32 proceeds to step S8.

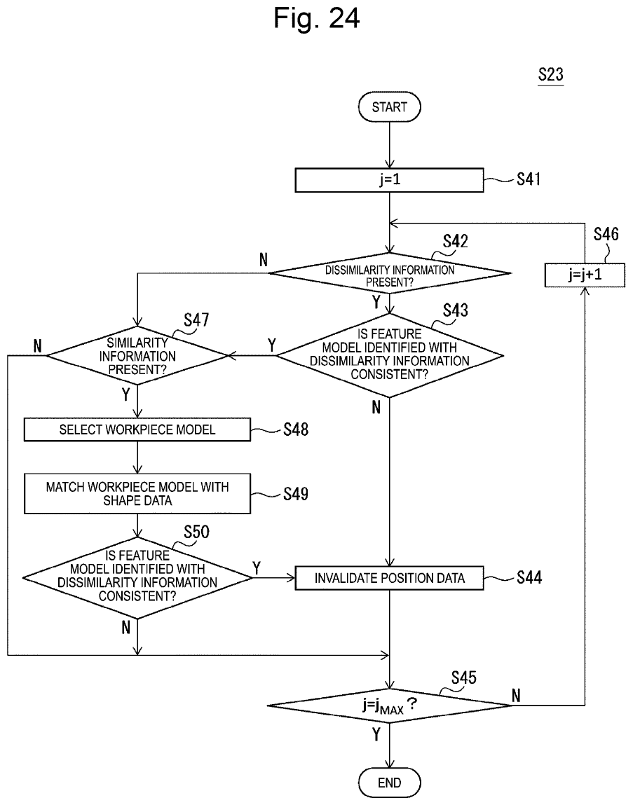

After executing the flow of FIG. 21 (i.e., i.e., after acquiring the similarity information SI and the dissimilarity information NI), the processor 32 executes the flow shown in FIG. 16. Here, the flow of FIG. 16 executed in the present embodiment is different from that executed in the above-described embodiment in terms of step S23. In the following, step S23 executed in the present embodiment will be described with reference to FIG. 24. Note that, in the flow shown in FIG. 24, the same processes as those in the flow in FIG. 19 are denoted by the same step numbers, and overlapping descriptions are omitted.

In the flow shown in FIG. 24, if the processor 32 determines NO in step S42 or determines YES in step S43, the processor 32 proceeds to step S47. In step S47, the processor 32 determines whether or not the similarity information SI has been acquired for the workpiece model 100Mₙ used in the matching for acquiring j-th position data PD_{3_}i.

As an example, it is assumed that, at the time point, the number “j” of the position data PD is set to j=1 and the first (i.e., the number j=1) position data PD_{3_1} stored in the detection result data DT of Table 1 has been obtained as a result of inappropriate matching of the workpiece model 100M₄ at the fourth orientation OR₄ with the shape data SD₁ as illustrated in FIG. 23(c). Since the dissimilarity shape NI has not been acquired for the workpiece model 100M₄, the processor 32 determines NO in step S42 and executes step S47.

In this case, the processor 32 can recognize that the similarity information SI_{4_1} for identifying the main body model 102M has been acquired in the above-described step S14 for the workpiece model 100M₄ used for acquiring the first position data PD_{3_1}. Therefore, in this case, the processor 32 determines YES.

As another example, it is assumed that j=1 has been set at this time point and the first position data PD_{3_1} has been obtained as a result that the workpiece model 100M₂ at the second orientation OR₂ is inappropriately matched with the shape data SD₁ as illustrated in FIG. 22(c). In addition, it is assumed that dissimilarity information NI_{2_3} for identifying that the protrusion model 106M of the workpiece model 100M₂ has a dissimilarity relationship with the feature of the workpiece 100 (FIG. 10(b)) at the third orientation OR₃ has been acquired.

In this case, the processor 32 determines YES for step S42. In addition, the protrusion model 106M of the workpiece model 100M₂ identified by the dissimilarity information NI_{2_3} is consistent with the feature (i.e., the protrusion 106) appearing in the shape data SD₁ of the workpiece 100 at the first orientation OR₁ as illustrated in FIG. 22(c). Therefore, the processor 32 determines YES in step S43.

In this case, the processor 32 can recognize that the similarity information SI_{2_1} for identifying the main body model 102M has been acquired in the above-described step S14 for the workpiece model 100M₂ used for acquiring the first position data PD_{3_1} in step S47. Therefore, in this case, the processor 32 determines YES.

Upon determining YES, the processor 32 proceeds to step S48. On the other hand, if the similarity information SI has not been acquired for the workpiece model 100Mₙ used for acquiring the j-th position data PD_{3_}i, the processor 32 determines NO, and proceeds to step S45.

In step S48, the processor 32 selects a workpiece model 100M different from the workpiece model 100Mₙ used to acquire the j-th position data PD_{3_}i from among the plurality of workpiece models 100M acquired in step S1 described above based on the similarity information SI.

For example, as described above, when the inappropriate matching illustrated in FIG. 22(c) is performed at the time of acquiring the first position data PD_{3_1}, the processor 32 refers to the similarity information SI_{2_1} acquired for the main body model 102M of the workpiece model 100M₂ at the second orientation OR₂. From the similarity information SI_{2_1}, the processor 32 can recognize that the main body model 102M of the workpiece model 100M₂ used for acquiring the first position data PD_{3_1} has a similarity relationship with the main body 102 of the workpiece 100 at the first orientation OR₁.

Then, the processor 32 refers to the association information I_{2_1} included in the similarity information SI_{2_1}, and selects the workpiece model 100M₁ at the first orientation OR₁ from the plurality of workpiece models 100Mₙ as a workpiece model 100Mₙ including the feature model having the similarity relationship with the main body model 102M of the workpiece model 100M₂ at the second orientation OR₂.

Alternatively, when the inappropriate matching illustrated in FIG. 23(c) is performed at the time of acquiring the first position data PD_{3_1}, the processor 32 refers to the similarity information SI_{4_1} acquired for the main body model 102M of the workpiece model 100M₄ at the fourth orientation OR₄ as described above. Then, the processor 32 refers to the association information I_{4_1} included in the similarity information SI_{4_1}, and selects the workpiece model 100M₁ at the first orientation OR₁ from the plurality of workpiece models 100Mₙ as a workpiece model 100Mₙ including the feature model having the similarity relationship with the main body model 102M of the workpiece model 100M₄ at the fourth orientation OR₄.

As described above, when the position data PD_{3_1} is acquired by matching the workpiece model 100M₂ or 100M₄ with the shape data SD₁, the processor 32 selects the workpiece model 100M₁ including the feature model 102M corresponding to the feature (the main body 102) identified by the similarity information SI_{2_1} or SI_{4_1} as having a similarity relationship with the feature model 102M from the plurality of workpiece models 100Mₙ. Therefore, the processor 32 functions as a model selection unit 64 (FIG. 20) configured to select the workpiece model 100M₁ from the plurality of workpiece models 100Mₙ.

In step S49, the processor 32 functions as the position data acquisition unit 58 and matches the workpiece model 100Mₙ selected in the immediately preceding step S48 with the shape data SDᵢ from which the j-th position data PD_{3_}i has been acquired again based on a predetermined matching algorithm. For example, in the case of the example of FIG. 22(c) or 23(c) described above, the processor 32 matches the workpiece model 100M₁ selected in the immediately preceding step S48 with the shape data SD₁.

In step S50, the processor 32 functions as the consistency determination unit 62 and determines whether or not the feature model identified by the dissimilarity information NI among the feature models included in the workpiece model 100Mₙ matched in the immediately preceding step S49 is consistent with the feature appearing in the shape data SDᵢ from which the j-th position data PD_{3_}i was acquired.

For example, when the workpiece model 100M₁ is matched with the shape data SD₁ in the immediately preceding step S49, the processor 32 determines whether or not the end surface model 110M identified by the dissimilarity information NI_{1_2} in the workpiece model 100M₁ is consistent with the feature appearing in the shape data SD₁.

To be specific, the processor 32 acquires a matching degree γ″ of the end surface model 110M and the feature of the shape data SD₁, and determines that the end surface model 110M identified by the dissimilarity information NI_{1_2} is consistent with the feature appearing in the shape data SD₁ (i.e., YES) if the matching degree γ″ exceeds a predetermined threshold value γₜₕ″ (γ″>γₜₕ″ or γ″<γₜₕ″).

When the workpiece model 100M₁ is matched with the shape data SD₁ (e.g., refer to FIG. 18), the processor 32 determines YES in step S50. When it is determined as YES, the processor 32 proceeds to step S44 and functions as the position data cancellation unit 60 to invalidate the first position data PD_{3_1} acquired in step S22 described above.

Here, if it is determined as YES in step S50, it means that, while the matching executed at the time of acquiring the first position data PD_{3_1} acquired in step S22 is inappropriate (FIG. 22(c) or FIG. 23(c)), the matching executed in step S49 is appropriate.

Therefore, if it is determined as YES in step S50, the processor 32 executes step S44 to invalidate the first position data PD_{3_1} acquired in step S22. On the other hand, if the feature model identified by the dissimilarity information NI is not consistent with the feature appearing in the shape data SDᵢ in step S50, the processor 32 determines NO and proceeds to step S45.

As described above, in the present embodiment, the processor 32 functions as the model acquisition unit 44, the information acquisition unit 46, the feature extraction unit 48, the model matching execution unit 50, the frequency calculation unit 52, the similarity determination unit 54, and the cancellation unit 60, the consistency determination unit 62, and the model selection unit 64 to acquire the dissimilarity information NI of the workpiece models 100Mₙ.

Therefore, the model acquisition unit 44, the information acquisition unit 46, the feature extraction unit 48, the model matching execution unit 50, the frequency calculation unit 52, the similarity determination unit 54, the inconsistency determination unit 56, the position data acquisition unit 58, the position data cancellation unit 60, the consistency determination unit 62, and the model selection unit 64 constitute a device 88 (FIG. 20) configured to acquire the dissimilarity information NI.

The information acquisition unit 46 of the device 88 acquires the similarity information SI_{2_1} (or SI_{4_1}) for identifying the feature model (the main body model 102M) having a similarity relationship with the feature (the main body 102) of the workpiece 100 at the first orientation OR₁ in the workpiece model 100M₂ (or 100M₄) at the second orientation OR₂ (or the fourth orientation OR₄) (step S14).

Then, when the position data acquisition unit 58 acquires the shape data PD_{3_1} by matching the workpiece model 100M₂ (or 100M₄) with the shape data SD₁, the model selection unit 64 selects, from the plurality of workpiece models 100Mₙ, the workpiece model 100M₁ at the first orientation OR₁ including the feature model 102M corresponding to the feature (the main body 102) identified by the similarity information SI_{2_1} (or SI_{4_1}) as having a similarity relationship with the feature model 102M (step S48).

In addition, when the position data acquisition unit 58 matches the workpiece model 100M₁ selected by the model selection unit 64 with the shape data SD₁ again (step S49), the consistency determination unit 62 determines whether or not the feature model (the end surface model 110M) identified by the dissimilarity information NI_{1_2} is consistent with the feature (the end surface 110) appearing in the shape data SD₁ identified by the dissimilarity information NI_{1_2} (step S50).

In addition, if the consistency determination unit 62 determines that the feature model 110M is consistent with the feature 110 (i.e., YES in step S50), the position data cancellation unit 60 invalidates the position data PD_{3_1} acquired by the position data acquisition unit 58 (step S44). According to this configuration, if the position data PD_{3_}i has been acquired by inappropriate matching as illustrated in FIG. 22(c) or FIG. 23(c) in step S22 described above, it is possible to prevent the position data PD_{3_}i from being used for the control in step S25 described above.

Note that, if it is determined as YES in step S50, the processor 32 may function as the position data acquisition unit 58 to acquire position data PD_{3_1}′ of the workpiece model 100M₁ matched with the shape data SD₁ again. In addition, the processor 32 may invalidate the original position data PD_{3_1} in the following step S44 and add the newly acquired position data PD_{3_1}′ to the detection result data DT.

Note that, as a result of step S22, a plurality of pieces of the position data PD may be acquired for one piece of the shape data SDᵢ. For example, in step S22, the processor 32 acquires position data PD_{3_1_1} by matching the workpiece model 100M₁ (FIG. 3) at the first orientation OR₁ with the shape data SD₁ illustrated in FIG. 22(b).

Along with this, in step S22, the processor 32 can acquire position data PD_{3_1_2} by matching the workpiece model 100M₂ at the second orientation OR₂ illustrated in FIG. 22(a) with the shape data SD₁ illustrated in FIG. 22(b). Table 2 below shows an example of a data structure of the detection result data DT when a plurality of pieces of position data PD_{3_1_1} and PD_{3_1_2} have been acquired for one piece of shape data SD₁ as described above.

TABLE 2

| Shape Data | Number | Position Data | Matching Degree | Plane Proportion | Exposure Rate |
|---|---|---|---|---|---|
| SD₁ | 1 | PD₃_1_1 | γ₁_1 | δ₁_1 | ε₁_1 |
| | 2 | PD₃_1_2 | γ₁_2 | δ₁_2 | ε₁_2 |
| SD₂ | 3 | PD₃_2 | γ₂ | δ₂ | ε₂ |
| . | . | . | . | . | . |
| . | . | . | . | . | . |
| . | . | . | . | . | . |
| SDᵢ | j | PD₃_i | γᵢ | δᵢ | εᵢ |

In this case, the total number i of the shape data SDᵢ appearing in the detection data DD may be different from the total number j of the position data PD_{3_}i acquired in step S22 (i<j). In this case, the processor 32 invalidates the position data PD_{3_1_2} obtained as a result of the inappropriate matching illustrated in FIG. 22(c) by executing the flow of FIG. 24. On the other hand, the processor 32 maintains the position data PD_{3_1_1} obtained as a result of appropriate matching.

Note that, the processor 32 may execute the flow shown in FIG. 12, 14, 16, 17, 19, 21, or 24 in accordance with a computer program PG that is stored in the memory 34 in advance. In addition, the functions of the device 80, 82, 84, 86, or 88 (i.e., the model acquisition unit 44, the information acquisition unit 46, the feature extraction unit 48, the model matching execution unit 50, the frequency calculation unit 52, the similarity determination unit 54, the inconsistency determination unit 56, the position data acquisition unit 58, the position data cancellation unit 60, the consistency determination unit 62, and the model selection unit 64) executed by the processor 32 may be functional modules realized by the computer program PG.

In addition, various changes can be made to the flow shown in FIG. 12, 14, 16, 17, 19, 21, or 24. For example, in the above-described embodiment, the processor 32 executes step S23 after step S22 (more specifically, step S34) in the flow of FIG. 16.

Alternatively, without being limited to the above, the processor 32 may execute step S23 after step S32 or S33 in FIG. 17. For example, when step S23 is executed after step S32, the processor 32 executes steps S41 to S45 of FIG. 19 or steps S41 to S50 of FIG. 24 based on the initial position data PD_{1_}i acquired in step S32. In addition, when NO is determined in step S43 (or YES is determined in step S50), the initial position data PD_{1_}i is invalidated in step S44.

In addition, the rough search RS in step S32 and the precise search PS in step S33 described above are examples of the method of acquiring the position data PD of the workpiece 100, and any modification may be made to the rough search RS or the precise search PR, or the position data PD of the workpiece 100 may be acquired by using any other method in which neither the rough search RS nor the precise search PR are executed.

In addition, step S2 may be omitted from the flow in FIG. 12, 14, or 21. In this case, the feature extraction unit 48 may be omitted from the device 82, 84, 86, or 88. Furthermore, step S12 may be omitted from the flow of FIG. 21. The inconsistency determination unit 56 can be omitted from the device 88.

In step S5 of FIG. 12, 14, or 21, the processor 32 may execute model matching similar to that in step S32 (rough search RS) or step S33 (precise search PS) described above. In addition, in step S6 of FIG. 12, 14, or 21, the processor 32 may obtain a frequency α by taking into account the detection result parameters PM such as a matching degree γᵢ, a plane proportion δᵢ, and an exposure rate εᵢ in addition to a matching degree β. For example, in step S6, the processor 32 may obtain a frequency α if the matching degree β exceeds the threshold value βₜₕ₁ and the detection result parameter PM satisfies a predetermined reference (e.g., the parameter exceeds a reference value).

In addition, in step S3 of FIG. 12, 14, or 21, the shape detection sensor 14 may not be necessarily disposed at a known position in the control coordinate system C (to be specific, the robot coordinate system C1). Then, the processor 32 may acquire the detection data DD obtained by repeatedly imaging the workpiece 100 at various orientations ORₙ one by one by using the shape detection sensor 14 disposed at an arbitrary position, and may execute the matching of step S5 for each piece of the detection data DD. Various changes can be made to the flow shown in FIG. 12, 14, 16, 17, 19, 21, or 24 as described above.

In addition, in the above-described embodiment, the functions of the devices 80, 82, 84, 86, and 88 (i.e., the model acquisition unit 44, the information acquisition unit 46, the feature extraction unit 48, the model matching execution unit 50, the frequency calculation unit 52, the similarity determination unit 54, the inconsistency determination unit 56, the position data acquisition unit 58, the position data cancellation unit 60, the consistency determination unit 62, and the model selection unit 64) are implemented in the controller 16.

However, the present invention is not limited thereto, and the functions of the device 80, 82, 84, 86, or 88 may be implemented in any other computer, for example, a teaching device (a teach pendant, a tablet-type portable terminal, etc.) that teaches the robot 12 an operation for the work of step S25, a PC, or the like. In this case, a processor of the teaching device or a computer such as a PC functions as the device 80, 82, 84, 86, or 88.

Note that, in the above-described embodiment, the shape detection sensor 14 has been described as being fixed to the end effector 28 (or the wrist flange 26b) and moved by the robot 12. However, the present invention is not limited thereto, and the shape detection sensor 14 may be fixed at a known position in the control coordinate system C (the robot coordinate system C1) using, for example, a support structure.

In addition, the shape detection sensor 14 is not limited to a three-dimensional vision sensor, but may be a laser scanner capable of detecting the three-dimensional shape of an object. Alternatively, the shape detection sensor 14 may include a two-dimensional camera and a distance measurement sensor capable of measuring a distance d to a subject. In addition, the detection data DD detected by the shape detection sensor 14 is not limited to the three-dimensional point group image data as illustrated in FIG. 6, but may be a data set of two-dimensional image data obtained by imaging by the two-dimensional camera and a distance d measured by the distance measurement sensor, or may be any other type of image data (e.g., distance image data).

Furthermore, the robot 12 is not limited to being the vertical articulated robot, and may be any other type of robot, such as a horizontal articulated robot, a parallel link robot, or the like. Although the present disclosure has been described through embodiments above, the embodiments described above do not limit the scope of the invention claimed in the claims.

### REFERENCE SIGNS LIST

10 Robot system
12 Robot
14 Shape detection sensor
16 Controller
32 Processor
44 Model acquisition unit
46 Information acquisition unit
48 Feature extraction unit
50 Model matching execution unit
52 Frequency calculation unit
54 Similarity determination unit
56 Inconsistency determination unit
58 Position data acquisition unit
60 Position data cancellation unit
62 Consistency determination unit
64 Model selection unit
100 Workpiece
100M Workpiece model

1. A device comprising:
a model acquisition unit configured to acquire a plurality of workpiece models modeling a workpiece at a plurality of orientations, each workpiece model including a feature model corresponding to a visual feature of the workpiece; and
an information acquisition unit configured to acquire dissimilarity information for identifying, in a first workpiece model at one of the plurality of orientations, a first feature model having a dissimilarity relationship with the feature of the workpiece at another of the plurality of orientations.

2. The device of claim 1, further comprising a feature extraction unit configured to extract, from each of the plurality of workpiece models, a plurality of the feature models included in the workpiece model, and assign an identification code to each of the plurality of feature models extracted,
wherein the information acquisition unit acquires the dissimilarity information in association with the identification code assigned to the first feature model.

3. The device of claim 1, further comprising:
a model matching execution unit configured to match the workpiece model with shape data of the workpiece detected by a shape detection sensor;
a frequency calculation unit configured to obtain a frequency at which the feature model included in the first workpiece model is consistent with the feature appearing in each piece of the shape data when the model matching execution unit matches the first workpiece model with the shape data at a plurality of orientations; and
a similarity determination unit configured to determine whether or not each of a plurality of the feature models included in the first workpiece model has the dissimilarity relationship, based on the frequency obtained by the frequency calculation unit for the plurality of feature models,
wherein the information acquisition unit acquires the dissimilarity information for the first feature model determined to have the dissimilarity relationship by the similarity determination unit, among the plurality of feature models included in the first workpiece model.

4. The device of claim 3, wherein the similarity determination unit determines that the feature model has the dissimilarity relationship when the frequency obtained by the frequency calculation unit is equal to or less than a predetermined threshold value.

5. The device of claim 3, further comprising an inconsistency determination unit configured to determine whether or not an inconsistency occurs between at least one of the plurality of feature models included in the first workpiece model and the feature appearing in the shape data, when the model matching execution unit executes the matching using the first workpiece model,
wherein the frequency calculation unit obtains the frequency at which the feature model other than the at least one of the plurality of feature models is consistent with the feature, when the inconsistency determination unit determines that the inconsistency occurs.

6. The device of claim 3, wherein
the model matching execution unit is configured to:
execute the matching using the shape data obtained by the shape detection sensor actually detecting a shape of the workpiece in a real space; or
execute the matching using the shape data acquired from a simulation in which the shape detection sensor simulatively detects a shape of the workpiece in a virtual space.

7. The device of claim 1, further comprising:
a position data acquisition unit configured to acquire position data of the workpiece in a control coordinate system by matching the workpiece model with shape data of the workpiece detected by the shape detection sensor disposed at a known position in the control coordinate system; and
a position data cancellation unit configured to invalidate the position data acquired by the position data acquisition unit when an inconsistency occurs between the shape data and the workpiece model matched with the shape data for the position data acquisition unit to acquire the position data.

8. The device of claim 7, further comprising a consistency determination unit configured to determine whether or not the first feature model identified by the dissimilarity information is consistent with the feature appearing in the shape data, when the position data acquisition unit acquires first position data by matching the first workpiece model with the shape data,
wherein the position data cancellation unit invalidates the first position data acquired by the position data acquisition unit when the consistency determination unit determines that the first feature model is inconsistent with the feature.

9. The device of claim 7, wherein the information acquisition unit further acquires similarity information for identifying a second feature model having a similarity relationship with the feature of the workpiece at the one of the plurality of orientations in a second workpiece model at the other of the plurality of orientations,
wherein the device further comprises:
a model selection unit configured to select, from the plurality of workpiece models, the first workpiece model including the feature model corresponding to the feature identified by the similarity information as having the similarity relationship with the second feature model, when the position data acquisition unit acquires second position data by matching the second workpiece model with the shape data; and
a consistency determination unit configured to determine whether or not the first feature model identified by the dissimilarity information is consistent with the feature appearing in the shape data when the position data acquisition unit matches the first workpiece model selected by the model selection unit with the shape data again, and
wherein the position data cancellation unit invalidates the second position data acquired by the position data acquisition unit, when the consistency determination unit determines that the first feature model is consistent with the feature.

10. A controller configured to control an operation of a robot configured to execute a predetermined work on the workpiece, the controller comprising the device of claim 1.

11. A robot system comprising:
a robot configured to execute a predetermined work on a workpiece;
a shape detection sensor configured to detect a shape of the workpiece; and
the device of claim 1.

12. A method comprising:
acquiring, by a processor, a plurality of workpiece models modeling a workpiece at a plurality of orientations, each workpiece model including a feature model corresponding to a visual feature of the workpiece; and
acquiring, by the processor, dissimilarity information for identifying, in a first workpiece model at one of the plurality of orientations, a first feature model having a dissimilarity relationship with the feature of the workpiece at another of the plurality of orientations.
